(19) United States
(12) Patent Application Publication
(10) Pub. No.: US 2020/0104228 A1
(43) Pub. Date: Apr. 2, 2020

(54) ASYNCHRONOUS SELF-PROVING TRANSACTIONS

(71) Applicant: RIPPLE LABS INC., San Francisco, CA (US)

(72) Inventor: Ethan Mac Brough, San Francisco, CA (US)

(21) Appl. No.: 16/144,780

(22) Filed: Sep. 27, 2018

(51) Int. Cl. G06F 11/34; G06F 9/50; H04L 9/30; G06F 9/46

(52) U.S. Cl. CPC G06F 11/3414; G06F 11/3404; G06F 2209/5011; H04L 9/30; G06F 9/466; G06F 9/5005

(57) ABSTRACT

Systems and techniques are provided for asynchronous self-proving transactions. A first resource tracking system may receive an executable script from a first computing device. The first resource tracking system may execute the executable script to generate transfer instructions. The first resource tracking system may implement a transfer based on the transfer instructions. The first resource tracking system may receive a call to the executable script including proof of a transfer on a second resource tracking system from a second computing device. The first resource tracking system may execute the executable script to generate second transfer instructions in response to the call to the executable script. The resource tracking system may implement a second transfer based on the second transfer instructions.

### BACKGROUND

A transaction may include two separate transfers which may take place on two separate ledgers. The separate ledgers may be stored on computing devices. The transaction may only be completed successfully after both of the two separate transfers have completed successfully. It may difficult to ensure the completion of both of the two separate transfers across the computing devices storing the ledgers when the two separate transfers are generated asynchronously.

### BRIEF SUMMARY

In an implementation, a first resource tracking system may receive an executable script from a first computing device. The first resource tracking system may execute the executable script to generate transfer instructions. The first resource tracking system may implement a transfer based on the transfer instructions. The first resource tracking system may receive a call to the executable script including proof of a transfer on a second resource tracking system from a second computing device. The first resource tracking system may execute the executable script to generate second transfer instructions in response to the call to the executable script. The resource tracking system may implement a second transfer based on the second transfer instructions.

Systems and techniques disclosed herein may allow for asynchronous self-proving transactions. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for asynchronous self-proving transactions according to an implementation of the disclosed subject matter.

FIG. 2 shows an example system suitable for asynchronous self-proving transactions according to an implementation of the disclosed subject matter.

FIG. 3 shows an example system suitable for asynchronous self-proving transactions according to an implementation of the disclosed subject matter.

FIG. 4A shows an example arrangement suitable for asynchronous self-proving transactions according to an implementation of the disclosed subject matter.

FIG. 4B shows an example arrangement suitable for asynchronous self-proving transactions according to an implementation of the disclosed subject matter.

FIG. 4C shows an example arrangement suitable for asynchronous self-proving transactions according to an implementation of the disclosed subject matter.

FIG. 4D shows an example arrangement suitable for asynchronous self-proving transactions according to an implementation of the disclosed subject matter.

FIG. 4E shows an example arrangement suitable for asynchronous self-proving transactions according to an implementation of the disclosed subject matter.

FIG. 4F shows an example arrangement suitable for asynchronous self-proving transactions according to an implementation of the disclosed subject matter.

FIG. 5A shows an example arrangement suitable for asynchronous self-proving transactions according to an implementation of the disclosed subject matter.

FIG. 5B shows an example arrangement suitable for asynchronous self-proving transactions according to an implementation of the disclosed subject matter.

FIG. 5C shows an example arrangement suitable for asynchronous self-proving transactions according to an implementation of the disclosed subject matter.

FIG. 5D shows an example arrangement suitable for asynchronous self-proving transactions according to an implementation of the disclosed subject matter.

FIG. 6 shows an example procedure suitable for asynchronous self-proving transactions according to an implementation of the disclosed subject matter.

FIG. 7 shows an example procedure suitable for asynchronous self-proving transactions according to an implementation of the disclosed subject matter.

FIG. 8 shows an example procedure suitable for asynchronous self-proving transactions according to an implementation of the disclosed subject matter.

FIG. 9 shows an example procedure suitable for asynchronous self-proving transactions according to an implementation of the disclosed subject matter.

FIG. 10 shows a computer according to an embodiment of the disclosed subject matter.

FIG. 11 shows a network configuration according to an embodiment of the disclosed subject matter.

### DETAILED DESCRIPTION

According to embodiments disclosed herein, asynchronous self-proving transactions may allow for transactions to be executed asynchronously on separate ledgers stored on any number of computing devices. Two separate ledgers may track two separate resource types. A first party that controls resources on a first of the ledgers may offer to transfer some of those resources to a second party in exchange for the second party transferring resources of a different type to the first party on the second of the ledgers. The first party may generate and commit an executable script. The executable script may include an exchange offer being made by the first party. The executable script may be committed on the first ledger, which may execute the executable script. This may result in the holding of the appropriate quantity of the resources controlled by the first party on the first ledger. The executable script may also be made available for viewing by other parties. A second party may wish to accept the exchange offer included in the executable script. The second party may generate its own executable script, which may be committed on the second ledger. The second ledger may execute the second executable script, which may result in the holding of the appropriate quantity of the resources controlled by the second party on the second ledger. Proof that the appropriate quantity of the resources controlled by the second party have been held on the second ledger may be passed into the executable script of the first party. The executable script of the first party may verify the received proof and cause the quantity of resources held on the first ledger to be transferred to the second party on the first ledger. This may complete the first transfer of the transaction for the exchange offer. Proof of the transfer may then be passed into the executable script of the second party. The executable script of the second party may verify the received proof and cause the quantity of resources held on the second ledger to be transferred to the first party on the second ledger, completing the second transfer of the transaction and completing the transaction in accordance with the exchange offer included in the executable script of the first party.

A party may control a resource pool on a resource tracking system. A resource tracking system may be any suitable computing device or system, with any suitable combination of hardware and software, such as, for example, a system run by a financial institution, a hardware or software component of a server system or computing device, or a distributed system, such as, for example, a cryptocurrency ledger or blockchain which may exist on a number of different computing devices and be reconciled in a collaborative fashion, or may be centralized. A resource tracking system may implement a ledger that tracks control of resources. For example, the resource tracking system may be a server system or other computing system that tracks a ledger for a branch of a bank, and may track the control of all accounts opened at that branch. A resource tracking system may track the control of resources for any number of parties. A party may control a resource pool on a resource tracking system. The resource pool for a party on a resource tracking system may include an identification of the party and quantities of each type of resource controlled by the party and tracked by the resource tracking system. A party may have more than one resource type tracked by an individual resource tracking system

For example, a resource tracking system that includes a blockchain for a cryptocurrency may include a resource pool for each party, for example, individual or organization, which owns some quantity of the cryptocurrency. The resource pool may identify the owner of the cryptocurrency, for example, using a cryptographic public key stored with the resource pool, rendering the cryptocurrency accessible only to a party with the corresponding private key. The resource pool may also include the quantity of cryptocurrency. A resource tracking system for a financial institution may include a ledger, for example, hosted on a server system. The resource pools may be accounts owned by account holders at the financial institution, and may track the various assets owned by the account holder and tracked by the financial institution. For example, a resource pool for a party may include a type and quantity of one or more currencies and types and quantities of other types of assets, such as stocks, bonds, certificates of deposit, and the like. Alternatively or in addition, resource pools may include and record ownership of other resources, such as commodities or any resource that may be commoditized, finished physical goods, raw materials, computing resources, real property, or any other resource that may be owned by an entity and transferred from one entity to another. The account holder may be identified by any suitable information, and may need proof of identity, such as, for example, a username and password for the account, in order to access the account. A resource tracking system for a server system may be, for example, some suitable combination of hardware and software for tracking resources and ownership of those resources on the server system. For example, the resource tracking system for a server system may track computing resources such as storage space or processor time owned by various users of the server system, where the users may be physical individuals or organizations, or virtual users of a system, such as system accounts, or other processes running on the server system.

A resource tracking system may track any type of resource. For example, a resource may be a currency, cryptocurrency, financial instrument, commodity, or computational resource such as processor time, volatile and non-volatile storage space, and network bandwidth. The record of ownership and quantity of a resource by the resource tracking system may also be the resource itself, or may be a record of ownership of a resource that exists separately. For example, in a resource tracking system that is a blockchain for a cryptocurrency, the record of ownership for some quantity of the cryptocurrency may be the cryptocurrency. In a resource tracking system that tracks ownership of commodities, the record of ownership may correspond to physical resources, for example, gold, oil, or other commodities, that exist separately. Such resources may be transferred by transferring ownership, though the physical instantiation of the resource may not necessarily be moved.

A first party may control resources of a first type in a resource pool on a first resource tracking system. The first party may generate an executable script that may include an exchange offer. The exchange offer may specify that the first party will transfer a quantity of resources of the first type into a resource pool controlled by another party on the first resource tracking system if some quantity of resources of a second type, different from the first type, are transferred into a resource pool controlled by the first party on a second resource tracking system.

The executable script of the first party may be an executable script in any suitable scripting language which may be executable on the first resource tracking system. The executable script may include any suitable data and functions that may be needed in order for the executable script to be properly executed on the first resource tracking system. For example, the executable script of the first party may include an escrow function which, when executed on the first resource tracking system, may cause the first resource tracking system to hold a specified quantity of resources from the resource pool controlled by the first party. The hold may be implemented through a transfer of the specified quantity of the resource from the resource pool controlled by the first party into a newly created escrow resource pool on the first resource tracking system. The executable script may include an identification of the resource pool controlled by the first party on the first resource tracking system and a signature that can be used to verify the first party. The signature may be any suitable signature generated, for example, with a cryptographic private key. For example, the signature may be a signature over the resource pool using the cryptographic private key. The identification of the resource pool and the signature may be used by the escrow function in placing the hold on the quantity of resources of the first type in the resource pool controlled by the first party on the first resource tracking system.

The executable script generated by the first party may include a resolving function. The resolving function may, when executed, resolve the transaction of the exchange offer of the executable script. The resolving function may verify that a second party has put the appropriate quantity of the resource of the second type on hold a second resource tracking system. The resolving function may also verify that the second party has properly authorized the transfer of that quantity of the second type of resource to a resource pool controlled by the first party on the second resource tracking system. The resolving function may also verify that any function in the executable script of the second party that may be able to cancel the completion of the transaction specified in the exchange offer cannot be invoked without proof that the cancel function in the executable script of the first party was invoked first. The resolving function may also verify that a resolving function in the executable script of the second party is properly constructed so that it will transfer the quantity of the second resource type from an escrow resource pool on the second resource tracking system to the resource pool controlled by the first party on the second resource tracking system once proof is available that the quantity of the first resource type has been transferred from the escrow resource pool on the first resource tracking system to the resource pool controlled by the second party on the first resource tracking system. The resolving function may also be able to cause the transfer of the quantity of the first resource type that was held by the escrow function from the escrow resource pool to the resource pool controlled by the second party on the first resource tracking system.

The executable script of the first party may include a cancel function. The cancel function may be invoked by the first party at any time before the resolving function has transferred the quantity of the first resource type from the escrow resource pool to the resource pool controlled by the second party on the first resource tracking system. The cancel function in the executable script of the first party may remove the hold on the quantity of the first resource type, undoing work done by the escrow function, for example, transferring the quantity of the first resource type from the escrow resource pool back into the resource pool controlled by the first party on the first resource tracking system. The cancel function may also destroy the executable script of the first party so that the exchange offer of the executable script can no longer be accepted by any second party. Invocation of the cancel function may generate public visible and publicly accessible proof that the cancel function was invoked.

A second party may control resources of a second type in a resource pool on a second resource tracking system. The second party may generate a script in order to accept an exchange offer included in an executable script of a first party.

The executable script generated by the second party may be an executable script in any suitable scripting language. The executable script may include any suitable data and functions that may be needed in order for the executable script to be properly executed on the second resource tracking system. The executable script of the second party may include an escrow function which, when executed on the second resource tracking system, may cause the second resource tracking system to hold a specified quantity of resources from the resource pool controlled by the second party. The hold may be implemented through a transfer of the specified quantity of the resource from the resource pool controlled by the second party into a newly created escrow resource pool on the second resource tracking system. The executable script may include an identification of the resource pool controlled by the second party of on the second resource tracking system and a signature that can be used to verify the second party. The signature may be any suitable signature generated, for example, with a cryptographic private key. For example, the signature may be a signature over the resource pool using the cryptographic private key. The identification of the resource pool and the signature may be used by the escrow function in placing the hold on the quantity of resources of the second type in the resource pool controlled by the second party on the second resource tracking system.

The executable script of the second party may include a resolving function. The resolving function may, when executed, resolve the transaction of the exchange offer of the executable script. The resolving function may verify that a first party has put the appropriate quantity of the resource of the first type on hold in a resource pool on a first resource tracking system. The resolving function may also verify that the first party has properly authorized the transfer of that quantity of the first type of resource to a resource pool controlled by the second party on the first resource tracking system. The resolving function of the executable script of the second party may also verify that the resolving function in the executable script of the first party includes the appropriate parameters so as to be able to transfer the appropriate quantity of the first resource type to the resource pool controlled by the second party on the first resource tracking system, as specified in the exchange offer of the executable script of the first party. The resolving function may also be able to cause the transfer of the quantity of the second resource type that was held by the escrow function from the escrow resource pool on the second resource tracking system to the resource pool controlled by the first party on the second resource tracking system in response to proof that the quantity of the first resource type was transferred from the escrow resource pool on the first resource tracking system to the resource pool controlled by the second party on the first resource tracking system.

The executable script of the second party may include a cancel function. The cancel function may be invoked when the executable script of the first party has its cancel function invoked. The cancel function in the executable script of the second party may verify that the invocation of the cancel function of the executable script of the first party was properly authorized. The cancel function of the executable script of the second party may remove the hold on the quantity of the second resource type, undoing work done by the escrow function, for example, transferring the quantity of the second resource type from the escrow resource pool back into the resource pool controlled by the second party on the second resource tracking system. The cancel function may also destroy the executable script of the second party so that it can no longer be executed.

A first party may make an exchange offer available by generating an executable script that includes the exchange offer and committing the executable script to a first resource tracking system. Commitment of the executable script to the first resource tracking system may be accomplished in the same manner that transactions are committed to the first resource tracking system. For example, the first resource tracking system may include a validator, which may be, for example, a number of computing systems that make up the first resource tracking system, as in a blockchain ledger, or may be separate computing systems selected based on any suitable criteria, all of which may vote on whether to commit transactions or scripts to the first resource tracking system. The validator for the first resource tracking system may also be a single trusted computing device or system. The validator may check the executable script of the first party to ensure that it is properly authorized. For example, a resource pool controlled by the first party and identified in the executable may include a public cryptographic key, and the executable script may include a signature based on a private cryptographic key. The validator may determine if the signature was based on the private cryptographic key that corresponds to the public cryptographic key of the resource pool controlled by the first party to determine if the executable script was generated by a party that is authorized to transfer resources out of the resource pool. The validator may also check any other aspects of the executable script of the first party before committing the executable script to the first resource tracking system. For example, the validator may ensure that the executable script is properly constructed and does not include malformed or malicious instructions.

After the validator of the first resource tracking system commits the executable script of the first party, the executable script may begin executing. The escrow function of the executable script of the first party may be invoked. The escrow function may place a hold on a quantity of a first resource type from the resource pool controlled by the first party on the first resource tracking system. The hold may be placed by, for example, transferring the quantity of the first resource type from the resource pool controlled by the first party into a newly created escrow resource pool on the first resource tracking system. The escrow function may return an identification of the newly created escrow resource pool on the first resource tracking system.

A second party may wish to accept the exchange offer included in the executable script of the first party that has been committed to the first resource tracking system. The second party may become aware of the committed executable script, and the exchange offer, of the first party in any suitable manner. For example, the first resource tracking system may be a publicly readable blockchain ledger which may make all committed executable scripts publicly viewable. An exchange offer may also be posted to separate systems or database, which may include an identification of the resource tracking system on which the executable script has been committed and an identification of the executable script along with the parameters of the exchange offer.

The second party may generate an executable script based on the executable script of the first party. The executable script of the second party may be committed to a second resource tracking system. Commitment of the executable script to the second resource tracking system may be accomplished in the same manner that transactions are committed to the second source tracking system. For example, the second resource tracking system may include a validator, which may be, for example, a number of computing systems that make up the second resource tracking system, as in a blockchain ledger, or may be separate computing systems selected based on any suitable criteria, all of which may vote on whether to commit transactions or scripts to the second resource tracking system. The validator for the second resource tracking system may also be a single trusted computing device or system. The validator of the second resource tracking system may check the executable script of the second party to ensure that it is properly authorized. For example, a resource pool controlled by the second party and identified in the executable script of the second party may include a public cryptographic key, and the executable script may include a signature based on a private cryptographic key. The validator may determine if the signature was based on the private cryptographic key that corresponds to the public cryptographic key of the resource pool controlled by the second party to determine if the executable script was generated by a party that is authorized to transfer resources out of the resource pool on the second resource tracking system. The validator may also check any other aspects of the executable script of the second party before committing the executable script to the second resource tracking system. For example, the validator may ensure that the executable script is properly constructed and does not include malformed or malicious instructions.

After the validator of the second resource tracking system commits the executable script of the second party, the executable script may begin executing. The escrow function of the executable script of the second party may be invoked. The escrow function may place a hold on a quantity of a second resource type from the resource pool controlled by the second party on the second resource tracking system. The hold may be placed by, for example, transferring the quantity of the second resource type from the resource pool controlled by the second party into a newly created escrow resource pool on the second resource tracking system. The escrow function may return an identification of the newly created escrow resource pool on the second resource tracking system.

The second party may receive the identification of the newly created escrow resource pool on the second resource tracking system that results from the escrow function of the executable script of the second party. The second party may call the executable script of the first party with proof that the escrow function of the executable script of the second party completed and that the quantity of the second resource type, as specified in the exchange offer, is held in the newly created escrow account on the second resource tracking system. The proof may include, for example, an identifier of the block of the second resource tracking system that includes the committed executable script of the second party, a copy of the executable script of the second party including the public key of the second party and a signature of the second party over the script data, the Merkle branch from the executable script of the second party to the root, the Merkle root of the block of the second resource tracking system that includes the committed executable script of the second party, and a signature over the Merkle root of the block of the second resource tracking system that includes the committed executable script of the second party from the validator of the second resource tracking system. Other parameters that may be passed to the executable script of the first party when called by the second party may include an identification of a resource pool controlled by the second party on the first resource tracking system and a signature from the second party over that resource pool.

The executable script of the first party, on being called by the second party and receiving the proof from the second party, may have its resolving function invoked. The resolving function may verify the proof provided by the second party. For example, the resolving function of the executable script of the first party may verify the signature over the Merkle root of the block of the second resource tracking system that includes the committed executable script of the second party from the validator of the second resource tracking system using the Merkle root of the block of the second resource tracking system that includes the committed executable script of the second party and the public key associated with the second resource tracking system, which may be publicly available data. The signature over the Merkle root may use the private key of validators of the second resource tracking system. The resolving function may verify that the Merkle branch from the executable script of the second party to the root includes the proper sequence of hashes using the Merkle root of the block of the second resource tracking system that includes the committed executable script of the second party. The resolving function may verify the signature from the second party over the resource pool controlled by the second party on the first resource tracking system using the pubic key associated with that resource pool. The resolving function may verify the signature of the second party over the executable script of the second party using the public key of the second party. The resolving function may verify that any cancel function included in the executable script of the second party cannot be invoked without proof that the executable script of the first party had its cancel function invoked first. The resolving function may verify that the resolving function of the executable script of the second party is properly set up to transfer the appropriate quantity of the second type of resource to the resource pool controlled by the first party on the second resource tracking system when presented with proof that the appropriate quantity of the first type of resource was transferred to a resource pool controlled by the second party on the first resource tracking system. The verifications may be attempted in any suitable order. If any of the verifications fail, the resolving function of the first party may exit without completing the transaction. When a verification is successful, the executable script of the first party may continue execution of the resolving function, performing other verifications, until any verification fails or all verifications are successful.

The resolving function of the executable script of the first party, after completing the verifications, may complete the transfer of the resource of the first type on the first resource tracking system. The executable script, running on the first resource tracking system, may cause the first resource tracking system to transfer the quantity of the first resource type from the escrow resource pool on the first resource tracking system to the resource pool controlled by the second party on the first resource tracking system. The first resource tracking system may provide proof that the transfer occurred to the first party, and may notify the second party with the results of the transfer.

The first party may call the resolving function of the executable script of the second party with proof that the resolving function of the executable script of the first party successfully completed the transfer of the appropriate quantity of the first resource type from the escrow resource pool to the resource pool controlled by the second party on the first resource tracking system. The proof may include, for example, an identifier of the block of the first resource tracking system that includes the recordation of the transfer, a copy of the transfer, the Merkle branch from the record of the transfer on the first resource tracking system, the Merkle root of the block of the first resource tracking system that includes the record of the transfer on the first resource tracking system, and a signature over the Merkle root of the block of the first resource tracking system that includes the record of the transfer from the validator of the first resource tracking system. The signature over the Merkle root may use the private key of validators of the first resource tracking system Other parameters that may be passed to the executable script of the second party when called by the first party may include an identification of a resource pool controlled by the first party on the second resource tracking system and a signature from the first party over that resource pool.

The executable script of the second party, on being called by the first party and receiving the proof from the first party, may have its resolving function invoked. The resolving function of the executable script of the second party may verify the proof provided by the first party. For example, the resolving function of the executable script of the second party may verify the signature over the Merkle root of the block of the first resource tracking system that includes the record of the transfer on the first resource tracking system from the validator of the first resource tracking system using the Merkle root of the block of the first resource tracking system that includes the record of the transfer on the first resource tracking system and the public key associated with the first resource tracking system, which may be publicly available data. The resolving function may verify that the Merkle branch from the record of the transfer on the first resource tracking system to the root includes the proper sequence of hashes using the Merkle root of the block of the first resource tracking system that includes the record of the transfer on the first resource tracking system. The resolving function may verify the signature from the first party over the resource pool controlled by the first party on the second resource tracking system using the pubic key associated with that resource pool. The resolving function may verify the signature of the first party over the record of the transfer on the first resource tracking system using the public key of the first party. The resolving function may verify that the transfer on the first resource tracking system transferred the appropriate quantity of the first type of resource from the escrow resource pool on the first resource tracking system to the resource pool controlled by the second party on the first resource tracking system. The verifications may be attempted in any suitable order. If any of the verifications fail, the resolving function of the second party may exit without completing the transaction. When a verification is successful, the executable script of the second party may continue execution of the resolving function, performing other verifications, until any verification fails or all verifications are successful.

The resolving function of the executable script of the second party, after completing the verifications, may complete the transfer of the resource of the second type on the second resource tracking system. The executable script, running on the second resource tracking system, may cause the second resource tracking system to transfer the quantity of the second resource type from the escrow resource pool on the second resource tracking system to the resource pool controlled by the first party on the second resource tracking system. The second resource tracking system may provide proof that the transfer occurred to the second party, and may notify the first party with the results of the transfer. If the transfer is successful, the transaction may be completed, and both the executable script of the first party and the executable script of the second party may be destroyed so that they are no longer invokable, preventing any other party from accepting the exchange offer in the executable script of the first party.

The executable script of the first party may include a cancel function. The cancel function may be invokable by the first party at any time before the transfer from the escrow resource pool on the first resource tracking system to the resource pool controlled by the second party on the first resource tracking system. The cancel function may be invoked with a signed message from the first party that indicates intent to cancel the transaction, destroying the executable script of the first party so that no party can accept the included exchange offer. The cancel function may verify the signature of the signed message using a public key of the first party. If the verification is successful, the executable script of the first party may cause the first resource transfer system to transfer the quantity of the first resource type from the escrow resource pool on the first resource transfer system back to the resource pool controlled by the first party on the first resource transfer system. The cancel function may then destroy the executable script of the first party, so that it is no longer invokable. Invocation of the cancel function may generate public visible and publicly accessible proof that the cancel function was invoked.

The executable script of the second party may include a cancel function. The resolving function of the executable script of the second party may have begun executing after the first party invokes the cancel function of the executable script of the first party. The second party may attempt to invoke the resolving function of the executable script of the first party using proof that the appropriate quantity of the second type of resource has been transferred into the escrow resource pool on the second resource tracking system. The attempted invocation of the resolving function of the executable script of the first party may fail, as the script may have been destroyed by invocation of its cancel function. The failure of the invocation may be reported back to the second party. The second party may then request proof of the cancellation from the first resource tracking system. The first resource tracking system may provide, to the second party, the recordation on the first resource tracking system of the invocation of the cancel function of the executable script of the first party. The cancel function of the executable script of the second party may verify that the public key associated with the recordation of the invocation of the cancel function is the public key that belongs to the first party. The cancel function of the executable script of the second party may verify the signature on the recordation of the invocation of the cancel function using the data from the recordation itself and the public key that belongs to the first party. The cancel function of the executable script of the second party may verify that the recordation of the invocation of the cancel function of the executable script of the first party is actually based on invocation of the cancel function of the executable script of the first party by comparing the cancel function in the executable script of the first party to the cancel function that was invoked by the first party based on the recordation of invocation of the cancel function. The cancel function of the executable script of the second party may verify the signature on the message used by the first party to invoke the cancel function of the executable script of the first party using a copy of the executable script of the first party and the public key that belongs to the first party. If all of the verifications are successful, the executable script of the second party may cause the second resource transfer system to transfer the quantity of the second resource type from the escrow resource pool on the second resource transfer system back to the resource pool controlled by the second party on the second resource transfer system. The cancel function may then destroy the executable script of the second party, so that it is no longer invokable.

The first party may use a client computing device when interacting with the first resource tracking system. The first party may be any party that wishes to make an exchange offer available on a resource tracking system on which they control a resource pool. The client computing device may be used by, for example, any suitable person, group, organization, or computer hardware and software, and may be any suitable computing device or system. For example, the client computing device may be a suitable computing device such as a laptop, used by person. The client computing device may be used by the first party, or may be used on behalf of the first party. For example, the first party may be a person, and the client computing device may be a bank computer system, which may be used to make an exchange offer available on behalf of the first party. The client computing device may also be, for example, a server system used by a server management system running on the server system. The client computing device may communicate with the first resource tracking system over any suitable wired or wireless connection to the connector computing device. The connection may be a network connection, such as a WAN or LAN connection, or may be internal bus connection, for example, within a computing system.

The second party may use a client computing device when interacting with the second resource tracking system. The second party may be any party that wishes to accept an exchange offer available on a resource tracking system on which they control a resource pool. The client computing device may be used by, for example, any suitable person, group, organization, or computer hardware and software, and may be any suitable computing device or system. For example, the client computing device may be a suitable computing device such as a laptop, used by person. The client computing device may be used by the second party, or may be used on behalf of the second party. For example, the second party may be a person, and the client computing device may be a bank computer system, which may be to accept an exchange offer on behalf of the second party. The client computing device may also be, for example, a server system used by a server management system running on the server system. The client computing device may communicate with the second resource tracking system over any suitable wired or wireless connection to the connector computing device. The connection may be a network connection, such as a WAN or LAN connection, or may be internal bus connection, for example, within a computing system.

In some implementations, a resource tracking system may be able to transfer specific resources between resource pools. For example, when transferring commodities, a resource tracking system may be able to transfer commodities held at a specific location between resource pools. The resource quantities for a resource with a physical instantiation may also indicate where the physical intention is located. For example, gold may be held at specific storage facility. The resource tracking system may transfer such resources by decrementing and incrementing in both resource pools a quantity of resources located in a particular location. For example, a resource pool may include gold stored at a storage facility and a storage facility B. The resource tracking system may transfer, to another resource pool, only gold from storage facility A. The resource tracking system may decrement the amount of gold recorded as stored at storage facility A in the source resource pool, and increase the amount of gold recorded as stored in storage facility A in the destination resource pool. Specific resources transferred by the resource tracking system may also include, for example, physical items of which there may be one or few copies, such as, for example, artwork including painting, sculptures, and prints, artifacts, collector's items such as sports memorabilia and comic books, jewelry, precious stones, and any other such item, or mass marketed goods, such as smartphones, foodstuffs, and so on.

Communication between the computing devices and systems for the parties may occur directly, for example, between any of the sender, the exchange participants, the receiver and the resource tracking systems, or may be routed in any suitable manner. Communications may occur directly using any suitable communications protocols, such as, for example, HTTPS. In some implementations, instead of messages being sent by one computing device or system to another, a computing device or system may check for a message on another computing device or system. Computing devices and systems may communicate using any suitable communications hardware, including, for example, any suitable wired and wireless network adapters.

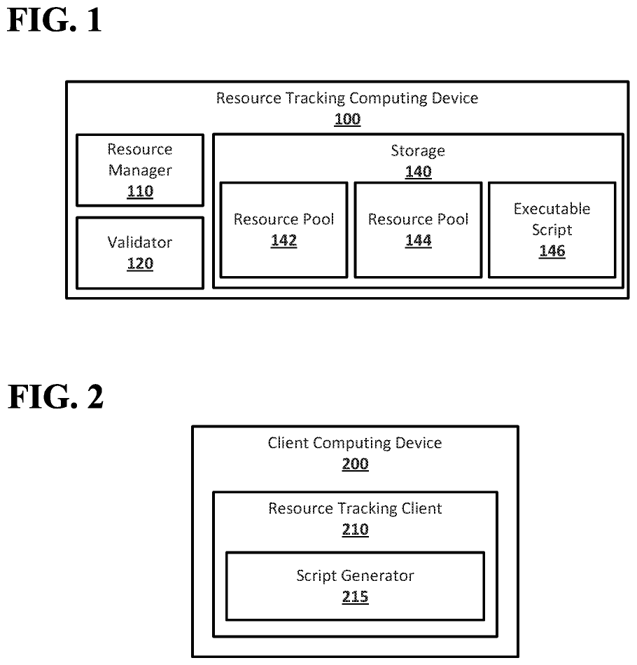

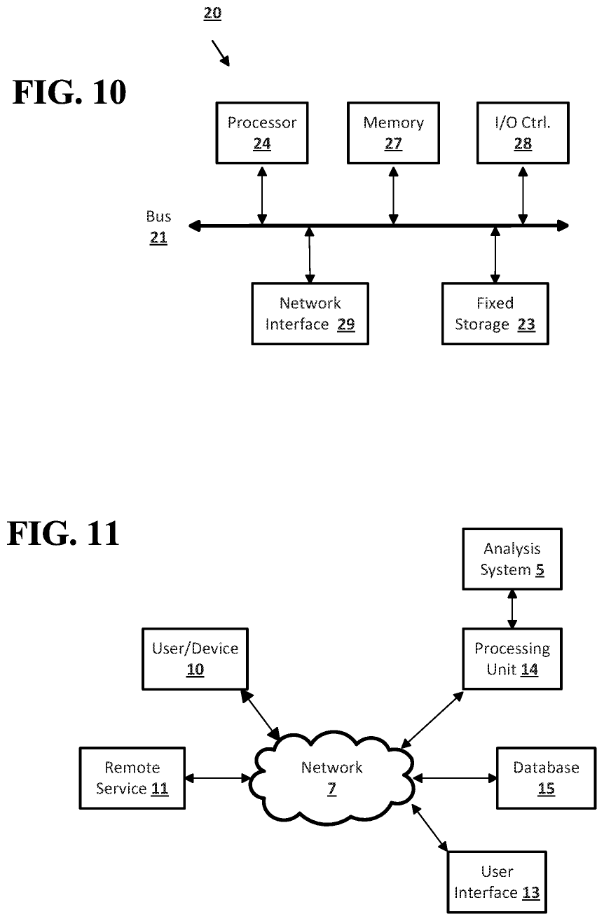

FIG. 1 shows an example system suitable for asynchronous self-proving transactions according to an implementation of the disclosed subject matter. A resource tracking computing device 100 may include a resource manager 110 and a storage 140. The resource tracking computing device 100 may be any suitable computing device, such as, for example, a computer 20 as described in FIG. 10, or component thereof, for implementing the resource manager 110 and the storage 140. The resource tracking computing device 100 may be a single computing device, or may include multiple connected computing devices, and may be, for example, a laptop, a desktop, an individual server, a server farm, or a distributed server system, or may be a virtual computing device or system. The resource tracking computing device 100 may be part of a computing system and network infrastructure, or may be otherwise connected to the computing system and network infrastructure. The resource tracking computing device 100 may be, for example, a system tracking a ledger for a bank or a branch of a bank, or may be a public cryptocurrency ledger that may distributed or centralized. The resource manager 210 may be any suitable combination of hardware and software on the resource tracking computing device 100 for managing resources belonging to various parties and tracked by the resource tracking computing device 100. The resources may be tracked in resource pools, such as, for example, the resource pools 142 and 144 in the storage 140. The storage 140 may store executable scripts, such as the executable script 146 along with the resource pools, for the various parties with resource tracked by the resource tracking computing device 100. The resource pools 142 and 144 may be records of resources owned by parties and tracked by the resource tracking computing device 100, including the types and quantities of the resources, and an identification of the party that owns or controls the resources in the resource pool. The resource tracking computing device 100 may be a resource tracking system, which may or may not be affiliated or belong to a particular person or organization, or may be a component of a server system. The resource pools 142 and 144 may be tracked based on transactions recorded in the storage 140, which may be a blockchain database system which may be implemented across any suitable number of storage devices on any suitable number of computing devices which may be part of the resource tracking computing device 100. Executable scripts, such as the executable script 146 may also be stored in blocks of the blockchain database system. The blockchain database system may track other occurrences transactions, such as the invocation of a cancel function in an executable script stored in a block of the blockchain database system.

The resource manager 110 may be any suitable combination of hardware and software on the resource tracking computing device 100 for managing resources belonging to various parties and tracked by the resource tracking computing device 100. The resource manager 110 may be able to receive transfer instructions, which may indicate that resources tracked by the resource tracking computing device 100 are to be transferred from one resource pool on the resource tracking computing device 100 to another resource pool on the resource tracking computing device 100. The resource manager 110 may be able to transfer resources between resource pools, such as the resource pool 142 and the resource pool 144, by decrementing the quantity of the resources in one resource pool and incrementing the quantity of the resources in the other resource pool by the same quantity. The resource manager 144 may be, for example, a validator system for the resource tracking computing device 100, and may increment and decrement registers by validating transactions that may then be written to blocks of a blockchain database system.

FIG. 2 shows an example system suitable for asynchronous self-proving transactions according to an implementation of the disclosed subject matter. A client computing device 200 may include a resource tracking client 210. The client computing device 200 may be any suitable computing device, such as, for example, a computer 20 as described in FIG. 10, or component thereof, for implementing the resource tracking client 210. The client computing device 200 may be a single computing device, or may include multiple connected computing devices, and may be, for example, a laptop, a desktop, an individual server, a server farm, or a distributed server system, or may be a virtual computing device or system. The client computing device 200 may be part of a computing system and network infrastructure, or may be otherwise connected to the computing system and network infrastructure. The resource tracking client 210 may be any suitable combination of hardware and software on the client computing device 200 for generating executable scripts that may be used to make or accept an exchange offer, sending executable scripts to resource tracking computing devices, sending data such as invocations of cancel functions and resolving functions to resource tracking computing devices, and receiving data such as notifications, results, and cancellation proofs from resource tracking computing devices. The client computing device 200 may also include a storage which may store, for example, blocks from a blockchain distributed database. For example, the client computing device 200 may be a computing device that is part of a resource tracking system such as the resource tracking computing device 100. The client computing device 200 may be used by a first party, which may be any suitable party that may wish to make an exchange offer available, or by a second party, which may be any suitable party that may wish to accept an exchange offer.

The resource tracking client 210 may be any suitable combination of hardware and software on the client computing device 200 for interacting with a resource tracking system such as the resource tracking computing device 100. The resource tracking client 210 may be used, for example, by a first party or a second party, to send an executable script to a resource tracking system, send an invocation of a cancel function of an executable script to a resource tracking system, send an invocation of a resolving function of an executable script to a resource tracking system, and receive results and notifications from a resource tracking system.

The resource tracking client 210 may include a script generator 215. The script generator 215 may be used to generate executable scripts. For example, a first party that wishes to make an exchange offer available may use the script generator 215 to generate an executable script that may include the exchange offer. A second party that wishes to accept an exchange offer may use the script generator 215 to generate an executable script that may be based on the executable script that includes the exchange offer being accepted. The script generator 215 may receive input from any suitable source, such as, for example, through a user interface of the resource tracking client 210.

The services implemented by the resource tracking client 210 may allow, for example, a party such as a person, business, institution, or organization to arrange a transfer of resources and to check the status of a transfer of resources on any resource tracking system used in the transfer. For example, the resource tracking client 210 may be software run on the client computing device 200, which may be computer, server system, or other suitable computing device controlled by a person business, institution, or organization.

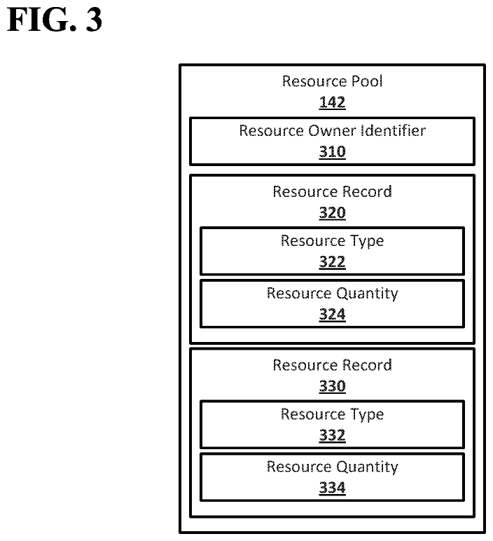

FIG. 3 shows an example system suitable for asynchronous self-proving transactions according to an implementation of the disclosed subject matter. The resource pool 142 on the resource tracking computing device 100 may include a resource owner identifier 310, and resource records 320 and 330. The resource owner identifier 310 may be any suitable identification of the party that owns the resources recorded in the resource pool 242. For example, the resource owner identifier may be a name of a person, organization, or user or process on a server system, an arbitrary name, a username and password combination, a passphrase or passcode, a unique number, or a cryptographic public key. The resource records 320 and 330 may include resource types 322 and 332, and resource quantities 324 and 334. The resource types 322 and 332 may indicate the type of resource that is recorded in the resource records 320 and 330. The resource types 322 and 332 may be any suitable resource of asset, such as, for example, currency, cryptocurrency, commodities, financial instruments, or computational resources. The resource quantities 322 and 324 may indicate the quantity of the resource types 322 and 332 owned by the party identified by the resource owner identifier 410 and tracked in the resource pool 342. The resource quantities 322 and 324 may be stored in, for example, registers or memory cells on the resource tracking computing device 100. The resource pool 142 may be, for example, based on transactions for a wallet address stored in the blocks of a blockchain database system stored across multiple storage devices.

The resource tracking computing device 100 may track resources in any suitable manner. For example, the resource tracking computing device 100 may pool resources by type, with each resource pool, such as the resource pool 142, tracking a particular resource type, such as the resource type 322. The resource pool 142 may then include the resource quantity 324 of the resource type 322 held by each party that owns any amount of the resource type 322, using resource owner identifiers such as the resource owner identifier 310.

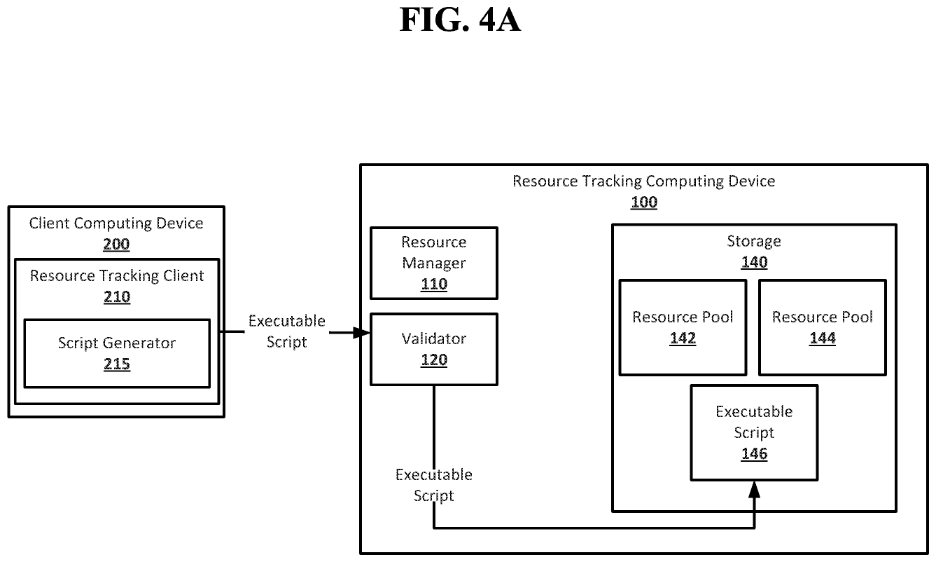

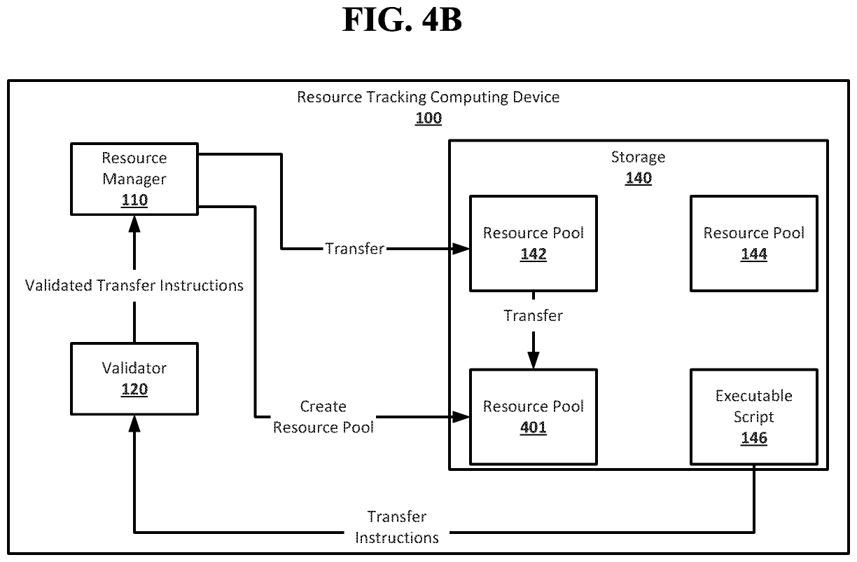

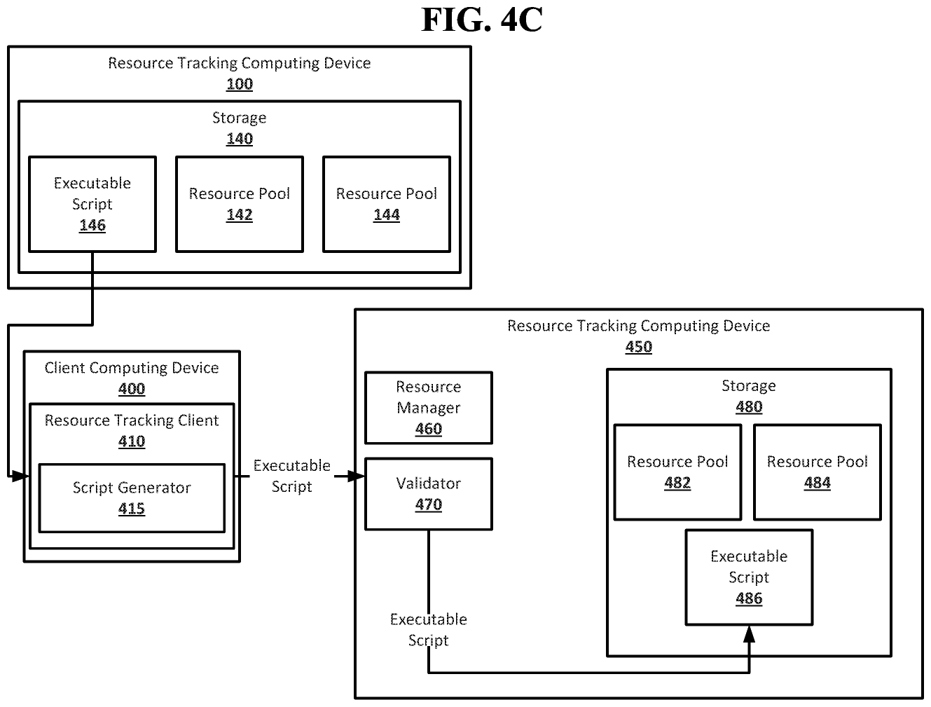

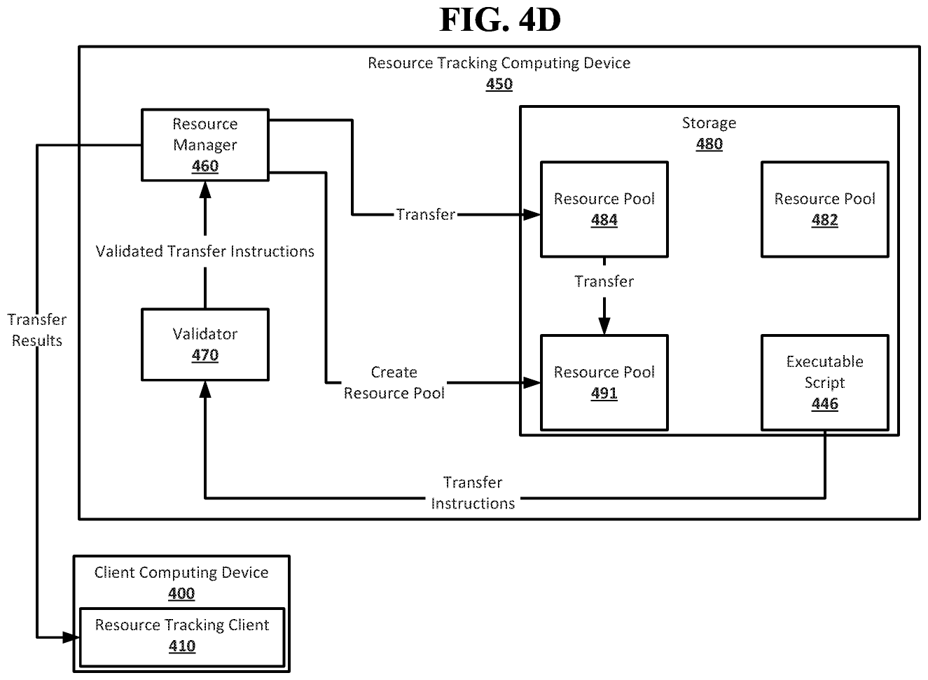

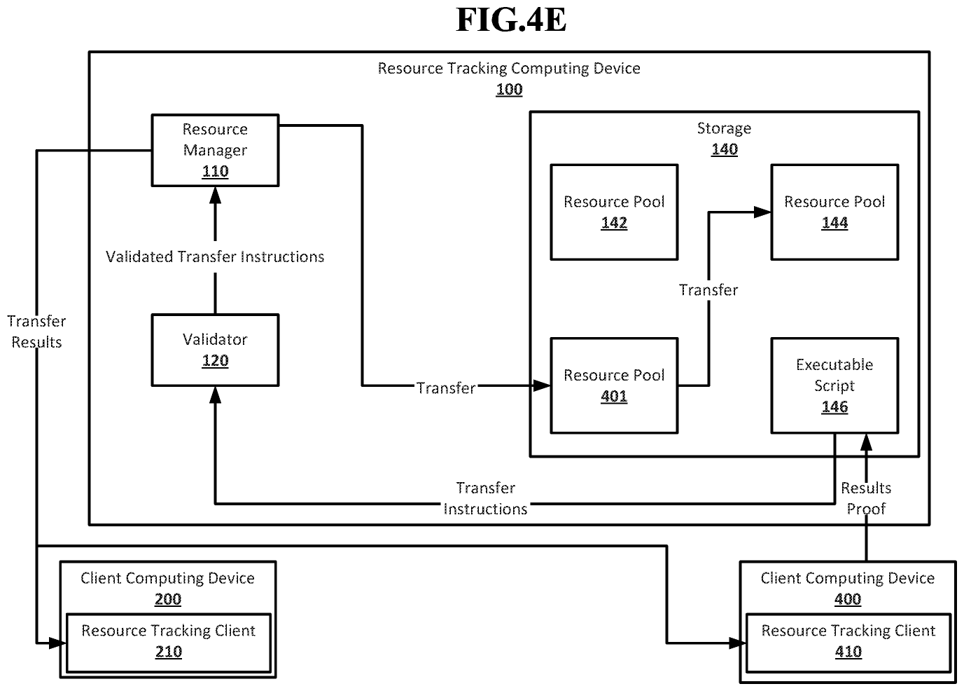

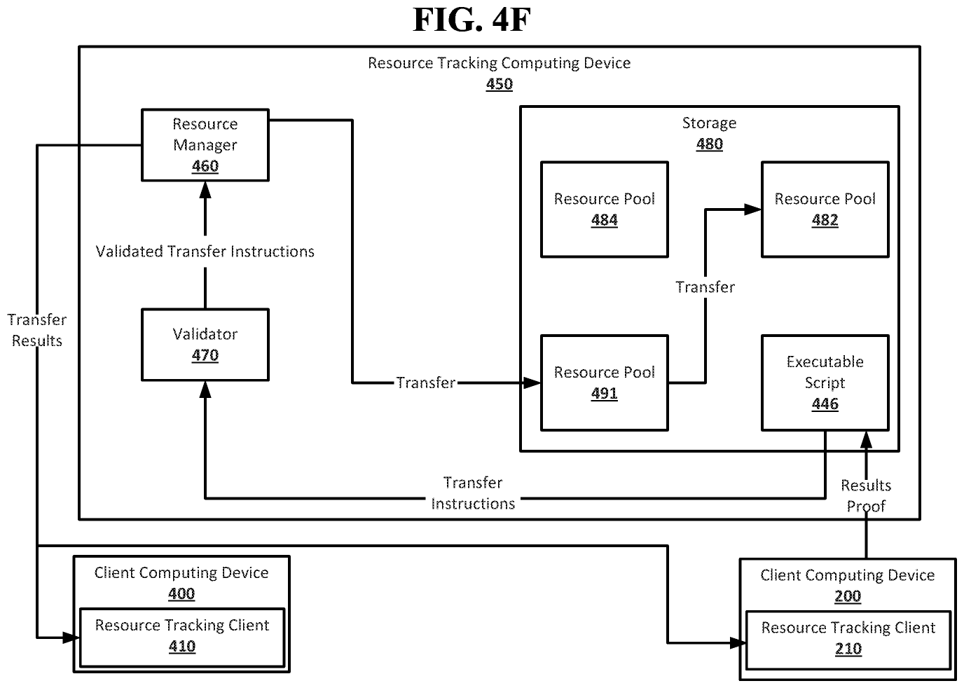

FIG. 4A shows an example arrangement suitable for asynchronous self-proving transactions according to an implementation of the disclosed subject matter. A first party may use the client computing device 200 to make an exchange offer available. The script generator 215 of the resource tracking client 210 may generate an executable script which may include any suitable data and functions for implementing the exchange offer. For example, the executable script may include an escrow function that may specify a quantity of a first resource type that the first party will transfer out from a resource pool, such as the resource pool 142, controlled by the first party. The executable script may include a resolving function that may be able to verify proof that a quantity of a second resource type has been transferred to an escrow resource pool on a second resource tracking system.

The executable script may be committed to the resource tracking computing device 100. For example, the validator 120, which may include any suitable number of computing devices, of the resource tracking computing device 100 may check the executable script to ensure that it is properly authorized. The executable script may identify the resource pool 142 on the resource tracking computing device 100. The resource pool 142 may include a public cryptographic key, and the executable script may include a signature based on a private cryptographic key for the resource pool 142 held by the first party. The validator 120 may determine if the signature in the executable script was based on the private cryptographic key that corresponds to the public cryptographic key of the resource pool 142. The validator 120 may also check any other aspects of the executable script before committing the executable script to the resource tracking computing device 100. For example, the validator 120 may ensure that the executable script is properly constructed and does not include malformed or malicious instructions. If the validator 120 commits the executable script, the executable script may be stored in the storage 140 of the resource tracking computing device 100 as the executable script 146. For example, the resource tracking computing device 100 may be a distributed blockchain system and the storage 140 may be a distributed blockchain database. The executable script 146 may be stored in a block added to the blockchain.

FIG. 4B shows an example arrangement suitable for asynchronous self-proving transactions according to an implementation of the disclosed subject matter. The executable script 146 may begin executing on the resource tracking computing device 100. The escrow function of the executable script 146 function may place a hold on a quantity of a first resource type from the resource pool 142. For example, the escrow function may generate transfer instructions which may be sent to the validator 120. The transfer instructions may specify the creation of a new resource pool 401 in the storage 140, which may serve as an escrow resource pool, into which the specified quantity of the first resource type may be transferred from the resource pool 142. The validator 120 may validate the transfer instructions, which may then be executed by the resource manager 110. For example, the new resource pool 401 may be created on a block of the blockchain, and the transfer instructions may be recorded on a block of the blockchain, indicating the transfer of the specified quantity of the first resource type from the resource pool 142 to the new resource pool 401.

FIG. 4C shows an example arrangement suitable for asynchronous self-proving transactions according to an implementation of the disclosed subject matter. A second party may use a client computing device 400 to accept the exchange offer made available by the executable script 146 on the resource tracking computing device 100. A script generator 415 of a resource tracking client 410 may generate an executable script which may include any suitable data and functions for accepting the exchange offer. For example, the executable script may include an escrow function that may specify a quantity of a second resource type, as specified in the exchange offer, that the second party will transfer out from a resource pool, such as the resource pool 482, controlled by the second party. The executable script may include a resolving function that may be able to verify proof that a quantity of the first resource type has been transferred to a resource pool controlled by the second party on the resource tracking computing device 100.

The executable script may be committed to the resource tracking computing device 450. For example, the validator 470, which may include any suitable number of computing devices, of the resource tracking computing device 450 may check the executable script to ensure that it is properly authorized. The executable script may identify the resource pool 482 on the resource tracking computing device 450. The resource pool 482 may include a public cryptographic key, and the executable script may include a signature based on a private cryptographic key for the resource pool 482 held by the second party. The validator 470 may determine if the signature in the executable script was based on the private cryptographic key that corresponds to the public cryptographic key of the resource pool 482. The validator 470 may also check any other aspects of the executable script before committing the executable script to the resource tracking computing device 450. For example, the validator 470 may ensure that the executable script is properly constructed and does not include malformed or malicious instructions. If the validator 470 commits the executable script, the executable script may be stored in the storage 480 of the resource tracking computing device 450 as the executable script 486. For example, the resource tracking computing device 450 may be a distributed blockchain system and the storage 480 may be a distributed blockchain database. The executable script 482 may be stored in a block added to the blockchain.

FIG. 4D shows an example arrangement suitable for asynchronous self-proving transactions according to an implementation of the disclosed subject matter. The executable script 446 may begin executing on the resource tracking computing device 450. The escrow function of the executable script 446 may place a hold on a quantity of a second resource type from the resource pool 484. For example, the escrow function may generate transfer instructions which may be sent to the validator 470. The transfer instructions may specify the creation of a new resource pool 491 in the storage 480, which may serve as an escrow resource pool, into which the specified quantity of the second resource type may be transferred from the resource pool 484. The validator 470 may validate the transfer instructions, which may then be executed by the resource manager 460. For example, the new resource pool 491 may be created on a block of the blockchain, and the transfer instructions may be recorded on a block of the blockchain, indicating the transfer of the specified quantity of the second resource type from the resource pool 484 to the new resource pool 491. The results of the transfer may be sent to the resource tracking client 410 of client computing device 400.

FIG. 4E shows an example arrangement suitable for asynchronous self-proving transactions according to an implementation of the disclosed subject matter. The client computing device 400 may call the executable script 146 to invoke the resolving function of the executable script 146. The resource tracking client 410 may send the proof of the results of the transfer from the resource pool 484 to the new resource pool 491 on the resource tracking computing device 450 to the resource tracking computing device 100 to call the executable script 146. The proof may include, for example, an identifier of the block of the blockchain of the resource tracking computing device 450 that includes the committed executable script 446, a copy of the executable script 446 including the public key of the second party and a signature of the second party over the script data, the Merkle branch from the executable script 446 to the root, the Merkle root of the block of the blockchain of the resource tracking computing device 450 that includes the committed executable script 446, and a signature over the Merkle root of the block of the blockchain of the resource tracking computing device 450 that includes the committed executable script 446 from the validator 470 of the resource tracking computing device 450. The signature over the Merkle root may use the private key of validators of the resource tracking computing device 450. Other parameters that may be passed to the executable script 146 may include an identification of the resource pool 144, which may be controlled by the second party on the resource tracking computing device 100, and a signature from the second party over the resource pool 144.

The executable script 146, on being called by the resource tracking client 410 and receiving the proof of the results of the transfer on the resource tracking computing device 450, may have its resolving function invoked. The resolving function of the executable script 146 may verify the signature over the Merkle root of the block of the resource tracking computing device 450 that includes the committed executable script 446 from the validator of the resource tracking computing device 450 using the Merkle root of the block of the resource tracking computing device 450 that includes the committed executable script 446 and the public key associated with the resource tracking computing device 450, which may be publicly available data. The signature over the Merkle root may use the private key of validators of the resource tracking computing device 450. The resolving function may verify that the Merkle branch from the executable script 446 to the root includes the proper sequence of hashes using the Merkle root of the block of the resource tracking computing device 450 that includes the committed executable script 446. The resolving function may verify the signature from the second party over the resource pool 144 on the resource tracking computing device 100 using the pubic key associated with the resource pool 144. The resolving function may verify the signature of the second party over the executable script 446 using the public key of the second party. The resolving function may verify that any cancel function included in the executable script 446 cannot be invoked without proof that the executable script 146 had its cancel function invoked first. The resolving function may verify that the resolving function of the executable script of the second party is properly set up to transfer the appropriate quantity of the second type of resource to the resource pool 482, which may be controlled by the first party on the resource tracking computing device 450, when presented with proof that the appropriate quantity of the first type of resource was transferred to the resource pool 144 on the resource tracking computing device 100. The verifications may be attempted in any suitable order. If any of the verifications fail, the resolving function of the first party may exit without completing the transaction. When a verification is successful, the executable script 146 may continue execution of the resolving function, performing other verifications, until any verification fails or all verifications are successful.

The resolving function of the executable script 146, after completing the verifications, may complete the transfer of the resource of the first type on the resource tracking computing device 100. The executable script 146, running on the resource tracking computing device 100, may send transfer instructions to the validator 120. After being validated, the transfer instructions may cause the resource tracking computing device 100 to transfer the quantity of the first resource type from the new resource pool 401 on the resource tracking computing device 100 to the resource pool 144, controlled by the second party, on the resource tracking computing device 100. For example, the resource manager 110 may write the transfer specified in the transfer instructions to a block of the blockchain of the resource tracking computing device 100. The resource tracking computing device 100 may provide proof that the transfer occurred to the resource tracking client 210 of the client computing device 200, and may also notify the resource tracking client 410 of the client computing device 400.

FIG. 4F shows an example arrangement suitable for asynchronous self-proving transactions according to an implementation of the disclosed subject matter. The client computing device 200 may call the resolving function of the executable script 446 with proof that the resolving function of the executable script 146 successfully completed the transfer of the appropriate quantity of the first resource type from the resource pool 401 to the resource pool 144, controlled by the second party, on the resource tracking computing device 100. The proof may include, for example, an identifier of the block of the resource tracking computing device 100 that includes the recordation of the transfer, a copy of the transfer, the Merkle branch from the record of the transfer on the resource tracking computing device 100, the Merkle root of the block of the blockchain of the resource tracking computing device 100 that includes the record of the transfer on the resource tracking computing device 100, and a signature over the Merkle root of the block of the blockchain of the resource tracking computing device 100 that includes the record of the transfer from the validator of the resource tracking computing device 100. The signature over the Merkle root may use the private key of validators of the resource tracking computing device 100. Other parameters that may be passed to the executable script 446 when called by the resource tracking client 210 may include an identification of a resource pool 482, which may be controlled by the first party on the resource tracking computing device 450, and a signature from the first party over the resource pool 482.

The executable script 446, on being called by the first party and receiving the proof from the first party, may have its resolving function invoked. The resolving function of the executable script 446 may verify the proof provided by the first party. For example, the resolving function of the executable script 446 may verify the signature over the Merkle root of the block of the resource tracking computing device 100 that includes the record of the transfer on the resource tracking computing device 100 from the validator of the resource tracking computing device 100 using the Merkle root of the block of the resource tracking computing device 100 that includes the record of the transfer on the resource tracking computing device 100 and the public key associated with the resource tracking computing device 100, which may be publicly available data. The resolving function may verify that the Merkle branch from the record of the transfer on the resource tracking computing device 100 to the root includes the proper sequence of hashes using the Merkle root of the block of the resource tracking computing device 100 that includes the record of the transfer on the resource tracking computing device 100. The resolving function may verify the signature from the first party over the resource pool 482 using the pubic key associated with that resource pool. The resolving function may verify the signature of the first party over the record of the transfer on the resource tracking computing device 100 using the public key of the first party. The resolving function may verify that the transfer on the resource tracking computing device 100 transferred the appropriate quantity of the first type of resource from the resource pool 401 on the resource tracking computing device 100 to the resource pool 144. The verifications may be attempted in any suitable order. If any of the verifications fail, the resolving function of the second party may exit without completing the transaction. When a verification is successful, the executable script 446 may continue execution of the resolving function, performing other verifications, until any verification fails or all verifications are successful.

The resolving function of the executable script 446, after completing the verifications, may complete the transfer of the resource of the second type on the resource tracking computing device 450. The executable script, running on the resource tracking computing device 450, may cause the resource tracking computing device 450 to transfer the quantity of the second resource type from the resource pool 491 on the resource tracking computing device 450 to the resource pool controlled by the first party on the resource tracking computing device 450. The resource tracking computing device 450 may provide proof that the transfer occurred to the resource tracking client 410, and may notify the resource tracking client 210 with the results of the transfer. If the transfer is successful, the transaction may be completed, and both the executable script 146 and the executable script 446 may be destroyed so that they are no longer invokable, preventing any other party from accepting the exchange offer in the executable script 146.

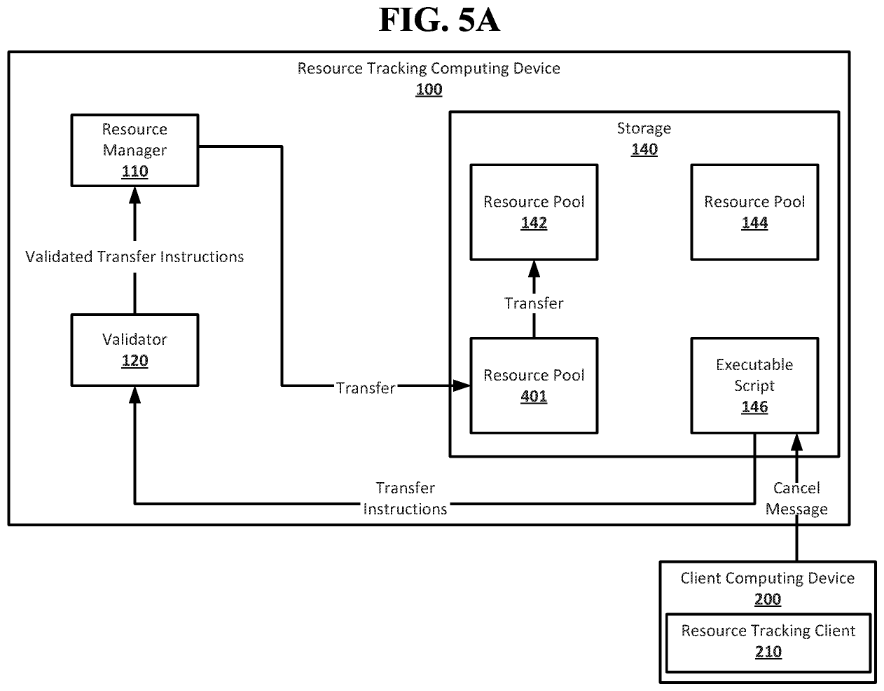

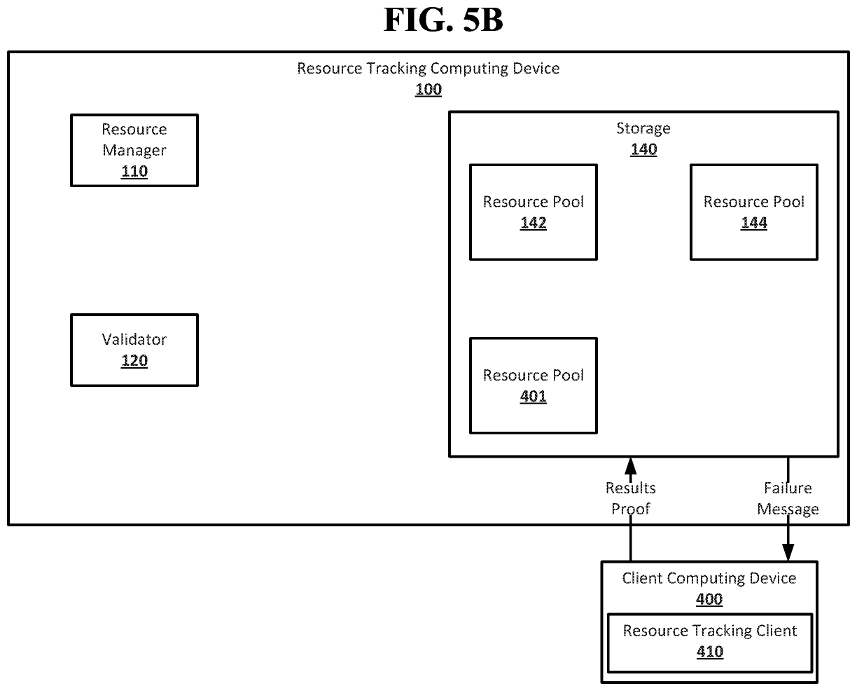

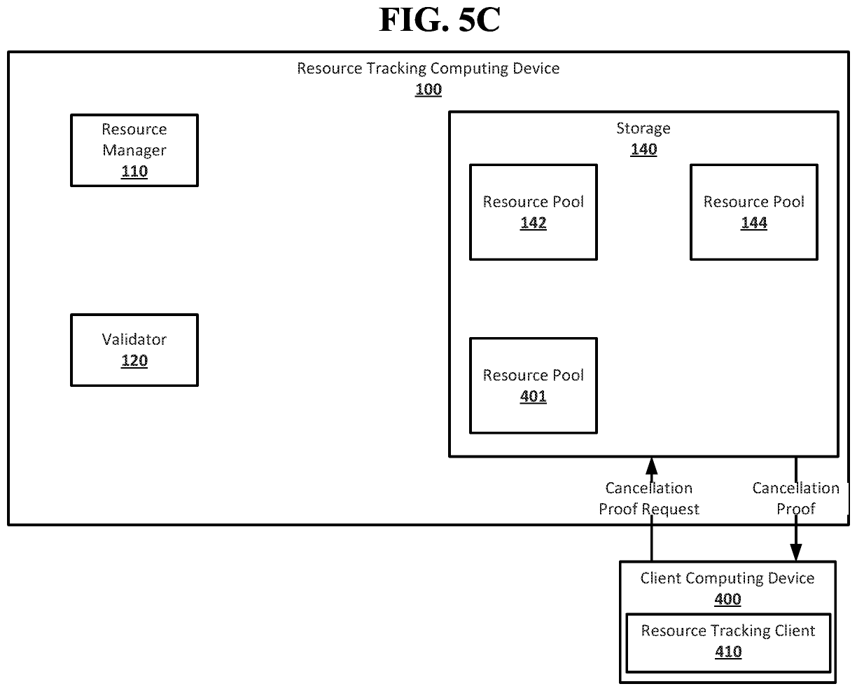

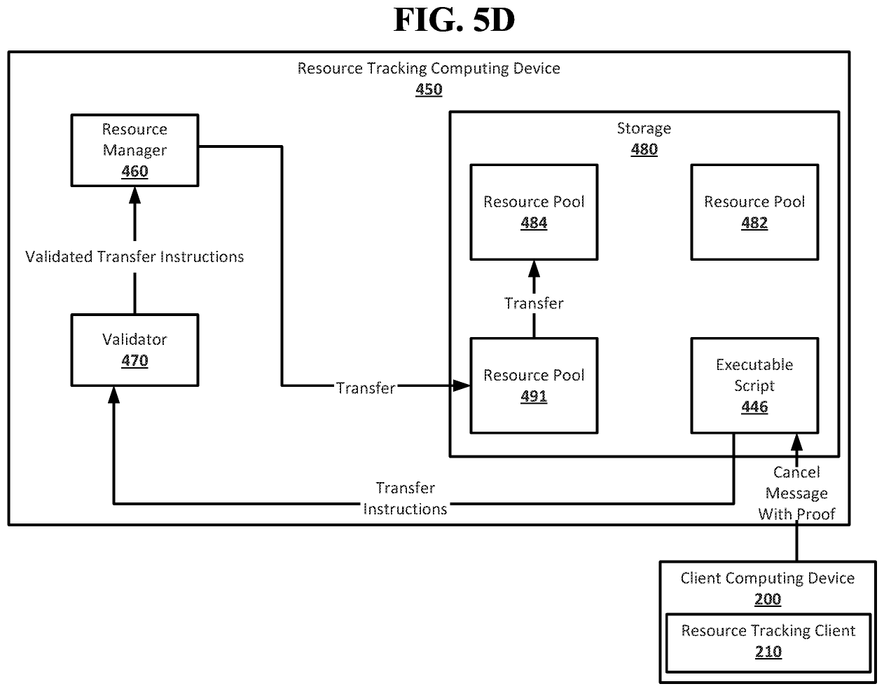

FIG. 5A shows an example arrangement suitable for asynchronous self-proving transactions according to an implementation of the disclosed subject matter. After the executable script 146 has been committed and begun executing on the resource tracking computing device 100 and the transfer has occurred from the resource pool 142 to the new resource pool 401, and before the second party has resolving function of the executable script 146, the first party may decide to cancel their exchange offer. The resource tracking client 210 of the client computing device 200 may send a cancel message to the resource tracking computing device 100. The cancel message may be a call to the executable script 146 invoking the cancel function of the executable script 146. The cancel message may be a signed message from the first party that indicates intent to cancel the transaction, destroying the executable script 146 so that no party can accept the exchange offer. The signed message may be generated by, for example, encrypting the concatenation of a text cancel command and an identifier of the executable script 146 using a private key of the first party. The signed message may be verified by the executable script 146 by decrypting the signed message using the public key of first party and checking that the decrypted contents of the signed message include the proper text cancel command and the identifier of the executable script 146.

If the verification of the cancel message by the executable script 146 is successful, the executable script 146 may generate transfer instructions that may be sent to the validator 120, where they may be validated. The transfer instructions may cause the resource transfer computing device 100 to transfer the quantity of the first resource type from the new resource pool 401 back to the resource pool 142, reversing the transfer implemented by the escrow function of the executable script 146. For example, the resource manager 110 may write the transfer instructions to a block of the blockchain of the resource tracking computing device 100. The cancel function may then destroy the executable script 146 so that it is no longer invokable. The destruction of the executable script 146 may be accomplished in any suitable manner. For example, an empty file with the same identifier as the executable script 146 may be written to a block of the blockchain, so that any attempted call to a script with that identifier result in a call to an empty script.

FIG. 5B shows an example arrangement suitable for asynchronous self-proving transactions according to an implementation of the disclosed subject matter. The second party may attempt to call the executable script 146 in order to accept the exchange offer after the first party has invoked the cancel function of the executable script 146. For example, the resource tracking client 410 of the client computing device 400 may have generated the executable script 446 in order to accept the exchange offer of the executable script 146, had the executable script 446 committed to the resource tracking computing device 450, and invoked the escrow function of the executable script 446, before the first party sent the cancel message to the resource tracking computing device 100. The first party may have then cancelled the exchange offer before the resource tracking client 410 could use the proof of the transfer into the new resource pool 491 on the resource tracking computing device 450 to invoke the resolving function of the executable script 146. An attempt to invoke the resolving function of the now-destroyed executable script 146 may result in a failure message being returned to the resource tracking client 410 on the client computing device 400, as the resolving function of the executable script 146 may no longer be invokable.

FIG. 5C shows an example arrangement suitable for asynchronous self-proving transactions according to an implementation of the disclosed subject matter. On receiving a failure message from the resource tracking computing device 100 after trying to call the executable script 146, the resource tracking client 410 may request proof that the first party cancelled that exchange offer. The cancellation proof may be, for example, the recordation, for example, in a block of the blockchain of the resource tracking computing device 100, of the invocation of the cancel function of the executable script 146. The cancellation proof may be transmitted to the resource tracking computing device 400. The cancellation proof may include data from the recordation of the invocation of the cancel function of the executable script 146, including the public key associated with the invocation.

FIG. 5D shows an example arrangement suitable for asynchronous self-proving transactions according to an implementation of the disclosed subject matter. The resource tracking client 210 may call the executable script 446 on the resource tracking computing device 450 with a cancel message and the cancellation proof received from the resource tracking computing device 100. The executable script 446 may verify that the public key associated with the recordation of the invocation of the cancel function of the executable script 146 is the public key that belongs to the first party. The cancel function of the executable script 446 may verify the signature on the recordation of the invocation of the cancel function using the data from the recordation itself and the public key that belongs to the first party. The cancel function of the executable script 446 may verify that the recordation of the invocation of the cancel function of the executable script of the first party is actually based on invocation of the cancel function of the executable script 146 by comparing the cancel function in the executable script 146 to the cancel function that was invoked by the first party based on the recordation of invocation of the cancel function. The cancel function of the executable script 446 may verify the signature on the cancel message used by the first party to invoke the cancel function of the executable script 146 using a copy of the executable script 146 and the public key that belongs to the first party.

If all of the verifications are successful, the executable 446 may generate transfer instructions that may be sent to the validator 470, where they may be validated. The transfer instructions may cause the resource transfer computing device 450 to transfer the quantity of the first resource type from the new resource pool 491 back to the resource pool 484, reversing the transfer implemented by the escrow function of the executable script 446. For example, the resource manager 460 may write the transfer instructions to a block of the blockchain of the resource tracking computing device 450. The cancel function may then destroy the executable script 446 so that it is no longer invokable. The destruction of the executable script 446 may be accomplished in any suitable manner. For example, an empty file with the same identifier as the executable script 446 may be written to a block of the blockchain, so that any attempted call to a script with that identifier result in a call to an empty script.

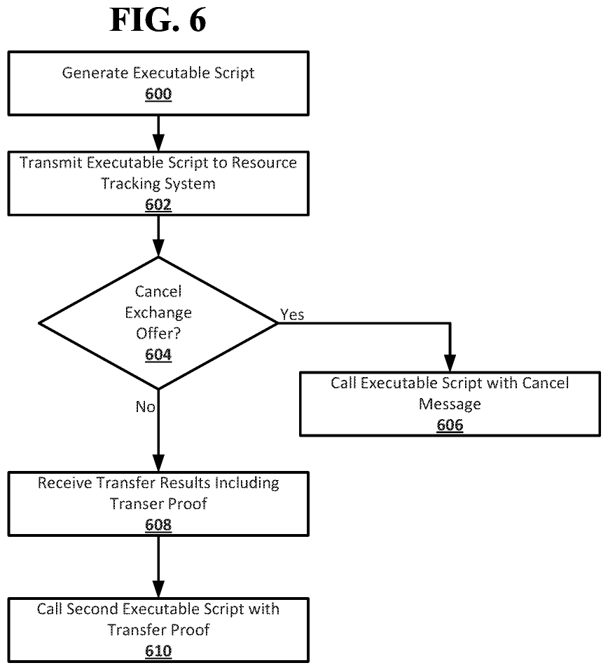

FIG. 6 shows an example procedure suitable for asynchronous self-proving transactions according to an implementation of the disclosed subject matter. At 600, an executable script may be generated. For example, a first party may use the resource tracking client 210 on the client computing device 200 to generate the executable script 146. The executable script 146 may include an exchange offer the first party wishes to make available, specifying that the first party will transfer a quantity of first resource type on the resource tracking computing device 100 if a second party transfers a quantity of a second resource type on the resource tracking computing device 450.

At 602, the executable script may be transmitted to a resource tracking system. For example, the client computing device 100 may transmit the executable script 146 to the resource tracking computing device 100. The resource tracking computing device 100 may validate, commit, and begin executing the executable script 146.

At 604, if the first party decides to cancel the exchange offer, flow may proceed to 606. Otherwise, flow may proceed to 608. The first party may decide to cancel the exchange offer at any time until the resolving function of the executable script 146 is called with proof of escrow by, for example, the resource tracking client 410 of the client computing device 400.

At 606, the first party may call the executable script with a cancel message. For example, the first party may use the resource tracking client 210 of the client computing device 200 to call the executable script 146 with a cancel message, invoking the cancel function of the executable script 146. The executable script 146 may verify the cancel message, reverse any transfer implemented by the executable script 146, and destroy itself.

At 608, transfer results including transfer proof may be received. For example, the resource tracking client 210 of the client computing device 200 may receive proof of a transfer that may have been implemented by the resolving function of the executable script 146 on the resource tracking computing device 100. The resolving function may have been invoked on a call to the executable script 146 from the resource tracking client 410, which may have generated the executable script 446 to accept the exchange offer of the executable script 146. The transfer may have been from the resource pool 401, which may be an escrow resource pool, to the resource pool 144, which may be controlled by the second party that generated the executable script 446.

At 610, a second executable script may be called with the transfer proof. For example, the resource tracking client 210 of the client computing device 200 may call the executable script 446 with the transfer proof, invoking the resolving function of the executable script 446. This may cause the resolving function of the executable script 446 to implement a transfer from the resource pool 491, which may an escrow resource pool, to the resource pool 482, which may be controlled by the first party, completing the transaction of the exchange offer.

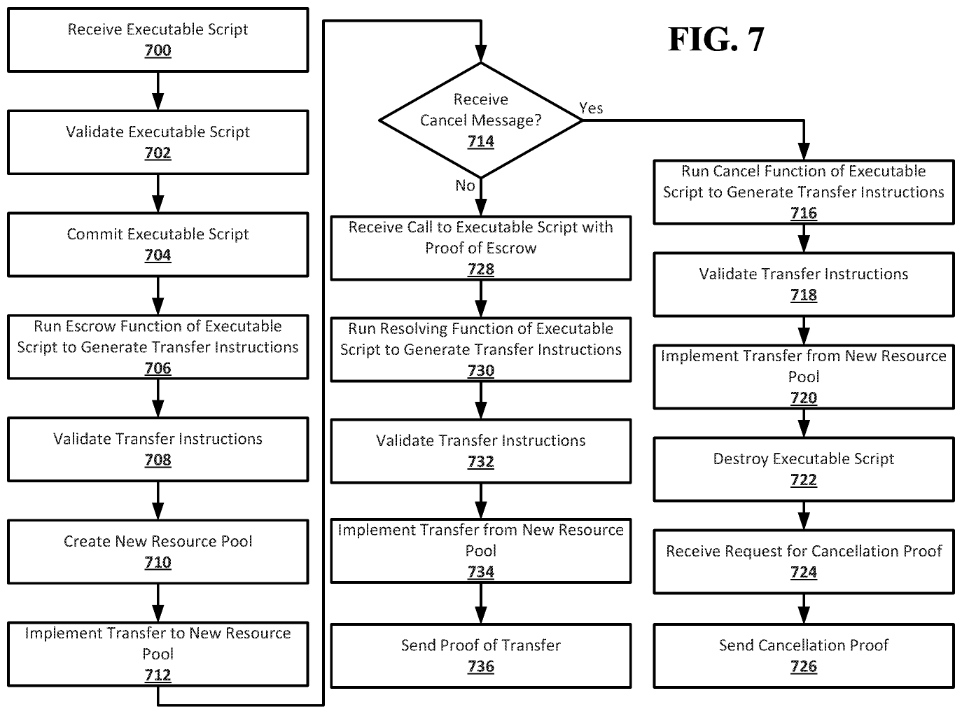

FIG. 7 shows an example procedure suitable for asynchronous self-proving transactions according to an implementation of the disclosed subject matter. At 700, an executable script may be received. For example, the resource tracking computing device 100 may receive the executable script 146, generated by the resource tracking client 210, from the client computing device 200.

At 702, the executable script may be validated. For example, the validator 120 may validate the executable script 146 according to the validation policies of the resource tracking computing device 100.

At 704, the executable script may be committed. For example, the executable script 146 may be committed to the resource tracking computing device 100. The executable script 146 may be stored in the storage 140 of the resource tracking computing device 100, for example, written to a block of a blockchain database of the resource tracking computing device 100.

At 706, an escrow function of the executable script may be run to generate transfer instructions. For example, the resource tracking computing device 100 may run the escrow function of the executable script 146 to generate transfer instructions to escrow the quantity of the first resource type that will be transferred on the resource tracking computing device 100.

At 708, the transfer instructions may be validated. For example, the transfer instructions generated by the executable script 146 may be sent to the validator 120. The validator 120 may validate the transfer instructions according to the validation policies of the resource tracking computing device 100.

At 710, a new resource pool may be created. For example, the resource manager 110 may implement the transfer instructions by creating a new resource pool 401 on the resource tracking computing device 100. The new resource pool 401 may serve as an escrow resource pool. The new resource pool 401 may be created in any suitable manner. For example, commitment of the transfer instructions to a block of the blockchain database of the resource tracking computing device 100 may create the new resource pool 401.

At 712, a transfer may be implemented to the new resource pool. For example, the resource manager 110 may implement the transfer instructions by transferring the specified quantity of the first resource type from the resource pool 142, controlled by the first party, to the new resource pool 401. The transfer may be implemented in any suitable manner, for example, through incrementing of registers in the new resource pool 401 and decrementing of registers in the resource pool 142, and/or through commitment of the transfer instructions to a block of the blockchain database of the resource tracking computing device 100.

At 714, if a cancel message is received, flow may proceed to 716. Otherwise, flow may proceed to 728.

At 716, a cancel function of the executable script may be run to generate transfer instructions. For example, a cancel message may be received from the client computing device 200 calling the executable script 146 and invoking the cancel function. The executable script 146 may verify the cancel message, and then may generate transfer instructions that may reverse the transfer implemented by the transfer instructions generated by the escrow function of the executable script 146.

At 718, the transfer instructions may be validated. For example, the transfer instructions generated by the cancel function of the executable script 146 may be sent to the validator 120. The validator 120 may validate the transfer instructions according to the validation policies of the resource tracking computing device 100.

At 720, a transfer may be implemented from the new resource pool. For example, the resource manager 110 may implement the transfer instructions generated by the cancel function by transferring the specified quantity of the first resource type from the new resource pool 401, back to the resource pool 142. The transfer may be implemented in any suitable manner, for example, through decrementing of registers in the new resource pool 401 and incrementing of registers in the resource pool 142, and/or through commitment of the transfer instructions to a block of the blockchain database of the resource tracking computing device 100.

At 722, the executable script may be destroyed. For example, the cancel function of the executable script 146 may cause the resource tracking computing device 100 to destroy the executable script 146. The executable script 146 may be destroyed in any suitable manner.

At 724, a request for cancellation proof may be received. For example, the resource tracking client 410 of the client computing device 400 may request cancellation proof from the resource tracking computing device 100. The resource tracking client 410 may have attempted to invoke the resolving function of the executable script 146, in order to accept the exchange offer, and received a failure message due to the cancellation of the exchange offer by the first party.

At 726, the cancellation proof may be sent. For example, the resource tracking computing device 100 may send the proof that the exchange offer was canceled by the first party to the resource tracking client 410 of the client computing device 400. The resource tracking client 410 may use the cancellation proof to call the executable script 446, invoking the cancel function of the executable script 446.

At 728, a call to the executable script with proof of escrow may be received. For example, the second party may have generated the executable script 446 to accept the exchange offer of the executable script 146. The escrow function of the executable script 446 may have generated transfer instructions for a transfer of the quantity of the second resource type into the new resource pool 491 on the resource tracking computing device 450. Proof of the escrow transfer may be provided to the resource tracking client 410 of the client computing device 400. The resource tracking computing device 100 may receive a call to the executable script 146 invoking the resolving function from the resource tracking client 410 of the client computing device 400. The call invoking the resolving function may include the proof of escrow.

At 730, the resolving function of the executable script may be run to generate transfer instructions. For example, the resolving function of the executable script 146 may be run on the resource tracking computing device 100. The resolving function may, after verifying the proof of escrow received from the client computing device 400 and the executable script 446, generate instructions that may transfer the quantity of the first resource type from the new resource pool 401 to the resource pool 144, controlled by the second party.

At 732, the transfer instructions may be validated. For example, the transfer instructions generated by the resolving function of the executable script 146 may be sent to the validator 120. The validator 120 may validate the transfer instructions according to the validation policies of the resource tracking computing device 100.

At 734, a transfer may be implemented from the new resource pool. For example, the resource manager 110 may implement the transfer instructions generated by the resolving function by transferring the specified quantity of the first resource type from the new resource pool 401 to the resource pool 144, controlled by the second party. The transfer may be implemented in any suitable manner, for example, through decrementing of registers in the new resource pool 401 and incrementing of registers in the resource pool 144, and/or through commitment of the transfer instructions to a block of the blockchain database of the resource tracking computing device 100.

At 736, proof of the transfer may be sent. For example, the resource tracking computing device 100, on completing the transfer from the resource pool 401 to the resource pool 144, may provide proof of the transfer to the resource tracking client 210 of the client computing device 200.

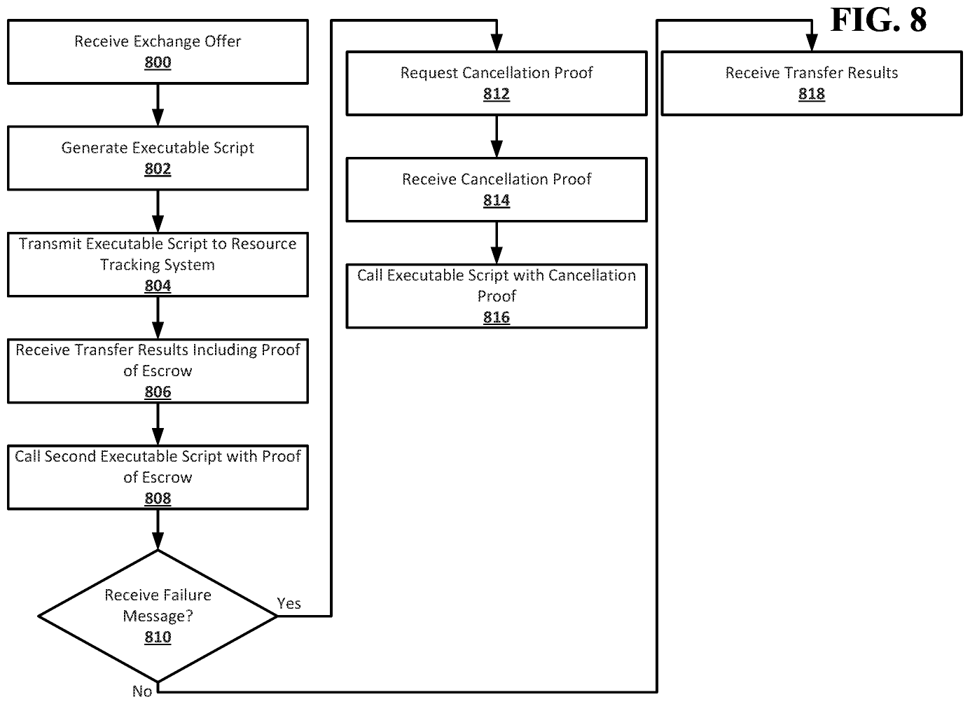

FIG. 8 shows an example procedure suitable for asynchronous self-proving transactions according to an implementation of the disclosed subject matter. At 800, an exchange offer may be received. For example, the resource tracking client 410 may become aware of the exchange offer made available by the executable script 146 on the resource tracking computing device 100 in any suitable manner. The resource tracking client 410 may receive the details of the exchange offer, including, for example, the quantity of the second resource type the second party would need to transfer on the resource tracking computing device 450 in order to fulfill the exchange offer.

At 802, an executable script may be generated. For example, a second party may use the resource tracking client 410 on the client computing device 400 to generate the executable script 446. The executable script 446 may be generated based on the exchange offer made available by a first party and received by the resource tracking client 410, such that running the executable script 446 on the resource tracking computing device 450 may accept the exchange offer.

At 804, the executable script may be transmitted to a resource tracking system. For example, the client computing device 400 may transmit the executable script 446 to the resource tracking computing device 450. The resource tracking computing device 450 may validate, commit, and begin executing the executable script 446.

At 806, transfer results transfer results including proof of escrow may be received. For example, the resource tracking client 410 of the client computing device 400 may receive proof of a transfer that may have been implemented by the escrow function of the executable script 446 on the resource tracking computing device 450. The escrow function may have been invoked on commitment of the executable script 446 to the resource tracking computing device 450. The transfer may have been from the resource pool 484, which may be controlled by the second party, to the resource pool 491, which may be an escrow resource pool.

At 808, a second executable script may be called with the proof of escrow. For example, the resource tracking client 410 of the client computing device 400 may call the executable script 146 with the proof of escrow, invoking the resolving function of the executable script 146. If the exchange offer has not been canceled, this may cause the resolving function of the executable script 146 to implement a transfer from the resource pool 401, which may an escrow resource pool, to the resource pool 144, which may be controlled by the second party, completing the first transfer of the exchange offer.

At 810, if a failure message is received, flow may proceed to 812. Otherwise, flow may proceed to 818. If the first party canceled the exchange offer before the resolving function of the executable script 146 was called with proof of escrow by the resource tracking client 410, the resource tracking client 410 may receive a failure message from the resource tracking computing device 100 when attempting to call the executable script 146.

At 812, cancellation proof may be requested. For example, the resource tracking client 410, on receiving a failure message from the resource tracking computing device 100, may request proof of the cancellation.

At 814, cancellation proof may be received. For example, the resource tracking client 410 on the client computing device 400 may receive cancellation proof from the resource tracking computing device 100. The cancellation proof may include any suitable data proving that the exchange offer included in the executable script 146 was cancelled by the first party.

At 816, the executable script may be called with the cancellation proof. For example, the resource tracking client 410 on the client computing device 400 may call the executable script 446 with a cancel message and the cancellation proof, invoking the cancel function of the executable script 446. The executable script 446 may verify the cancellation proof, reverse any transfer implemented by the executable script 446, and destroy itself.

At 818, transfer results may be received. For example, the resource tracking client 410 of the client computing device 400 may receive proof of a transfer that may have been implemented by the resolving function of the executable script 146 on the resource tracking computing device 100. The resolving function may have been invoked on a call to the executable script 146 from the resource tracking client 410, which may have generated the executable script 446 to accept the exchange offer of the executable script 146. The transfer may have been from the resource pool 401, which may be an escrow resource pool, to the resource pool 144, which may be controlled by the second party.

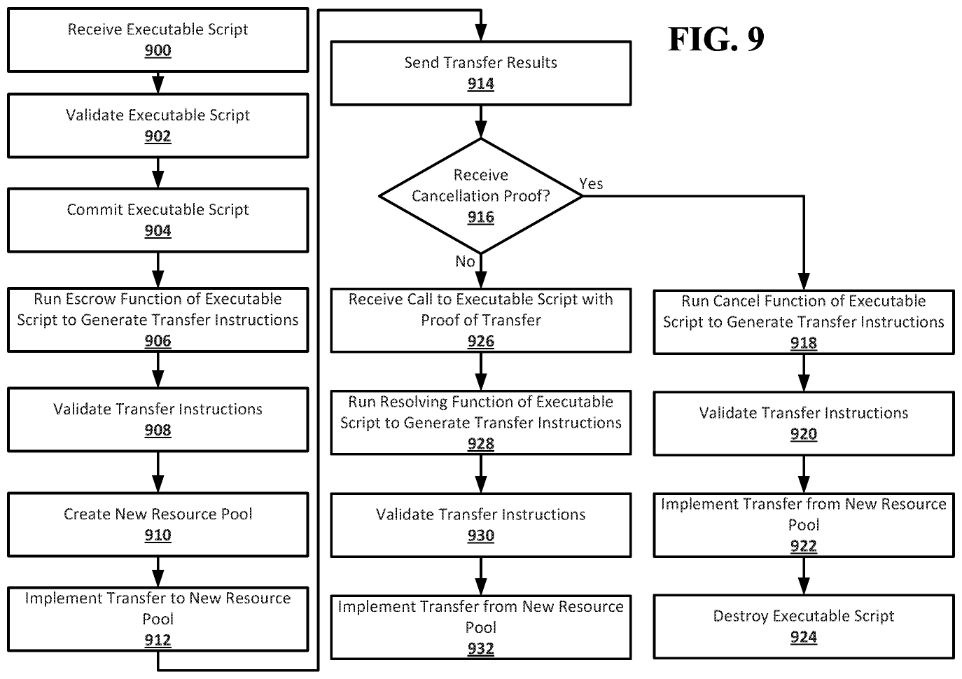

FIG. 9 shows an example procedure suitable for asynchronous self-proving transactions according to an implementation of the disclosed subject matter. At 900, an executable script may be received. For example, the resource tracking computing device 450 may receive the executable script 446, generated by the resource tracking client 410, from the client computing device 400.

At 902, the executable script may be validated. For example, the validator 470 may validate the executable script 446 according to the validation policies of the resource tracking computing device 450.

At 904, the executable script may be committed. For example, the executable script 446 may be committed to the resource tracking computing device 450. The executable script 446 may be stored in the storage 480 of the resource tracking computing device 450, for example, written to a block of a blockchain database of the resource tracking computing device 450.

At 906, an escrow function of the executable script may be run to generate transfer instructions. For example, the resource tracking computing device 450 may run the escrow function of the executable script 446 to generate transfer instructions to escrow the quantity of the second resource type that will be transferred on the resource tracking computing device 450.

At 908, the transfer instructions may be validated. For example, the transfer instructions generated by the executable script 446 may be sent to the validator 470. The validator 470 may validate the transfer instructions according to the validation policies of the resource tracking computing device 450.

At 910, a new resource pool may be created. For example, the resource manager 460 may implement the transfer instructions by creating a new resource pool 491 on the resource tracking computing device 450. The new resource pool 491 may serve as an escrow resource pool. The new resource pool 491 may be created in any suitable manner. For example, commitment of the transfer instructions to a block of the blockchain database of the resource tracking computing device 450 may create the new resource pool 491.

At 912, a transfer may be implemented to the new resource pool. For example, the resource manager 470 may implement the transfer instructions by transferring the specified quantity of the second resource type from the resource pool 484, controlled by the second party, to the new resource pool 491. The transfer may be implemented in any suitable manner, for example, through incrementing of registers in the new resource pool 491 and decrementing of registers in the resource pool 484, and/or through commitment of the transfer instructions to a block of the blockchain database of the resource tracking computing device 450.

At 914, the results of the transfer may be sent. For example, the resource tracking computing device 450 may send the results of the transfer to the resource tracking client 410 on the client computing device 400. The results of the transfer may serve as proof of escrow which the resource tracking client 410 may use to call the executable script 146 to invoke the resolving function of the executable script 146.

At 916, if a cancellation proof is received, flow may proceed to 918. Otherwise, flow may proceed to 926. For example, cancellation proof may be received from the resource tracking client 410, which may have received the cancellation proof from the resource tracking computing device 100 after attempting to call the executable script 146. The first party may have cancelled the exchange offer included in the executable script 146, resulting in the destruction of the executable script 146.

At 918, a cancel function of the executable script may be run to generate transfer instructions. For example, a cancel message, with cancellation proof, may be received from the resource tracking client 410 of the client computing device 400, calling the executable script 446 and invoking the cancel function. The executable script 446 may verify the cancel message and the cancellation proof, and then may generate transfer instructions that may reverse the transfer implemented by the transfer instructions generated by the escrow function of the executable script 446.

At 920, the transfer instructions may be validated. For example, the transfer instructions generated by the cancel function of the executable script 446 may be sent to the validator 470. The validator 470 may validate the transfer instructions according to the validation policies of the resource tracking computing device 450.

At 922, a transfer may be implemented from the new resource pool. For example, the resource manager 460 may implement the transfer instructions generated by the cancel function by transferring the specified quantity of the second resource type from the new resource pool 491, back to the resource pool 484. The transfer may be implemented in any suitable manner, for example, through decrementing of registers in the new resource pool 491 and incrementing of registers in the resource pool 484, and/or through commitment of the transfer instructions to a block of the blockchain database of the resource tracking computing device 100.

At 924, the executable script may be destroyed. For example, the cancel function of the executable script 446 may cause the resource tracking computing device 450 to destroy the executable script 446. The executable script 446 may be destroyed in any suitable manner.

At 926, a call to the executable script with proof of transfer may be received. For example, the executable script may have generated transfer instructions for a transfer of the quantity of the first resource type into the resource pool 144 on the resource tracking computing device 100 after invocation of the resolving function of the executable script 146. Proof of the transfer on the resource tracking computing device 100 may be provided to the resource tracking client 210 of the client computing device 200. The resource tracking computing device 450 may receive a call to the executable script 446 invoking the resolving function from the resource tracking client 210 of the client computing device 200. The call invoking the resolving function may include the proof of transfer.

At 928, the resolving function of the executable script may be run to generate transfer instructions. For example, the resolving function of the executable script 446 may be run on the resource tracking computing device 450. The resolving function may, after verifying the proof of transfer received from the resource tracking client 210 of the client computing device 200 and the executable script 146, generate instructions that may transfer the specified quantity of the second resource type from the new resource pool 491 to the resource pool 482, controlled by the first party.

At 930, the transfer instructions may be validated. For example, the transfer instructions generated by the resolving function of the executable script 446 may be sent to the validator 470. The validator 470 may validate the transfer instructions according to the validation policies of the resource tracking computing device 450.

At 932, a transfer may be implemented from the new resource pool. For example, the resource manager 460 may implement the transfer instructions generated by the resolving function by transferring the specified quantity of the second resource type from the new resource pool 491 to the resource pool 482, controlled by the first party. The transfer may be implemented in any suitable manner, for example, through decrementing of registers in the new resource pool 491 and incrementing of registers in the resource pool 482 and/or through commitment of the transfer instructions to a block of the blockchain database of the resource tracking computing device 450. The transfer may complete the transaction of the exchange offer.

Embodiments of the presently disclosed subject matter may be implemented in and used with a variety of component and network architectures. FIG. 10 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 11.

Many other devices or components (not shown) may be connected in a similar manner, such as document scanners, digital cameras, auxiliary, supplemental, or backup systems, or the like. Conversely, all of the components shown in FIG. 10 need not be present to practice the present disclosure. The components can be interconnected in different ways from that shown. The operation of a computer such as that shown in FIG. 10 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 11 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed on a data processing apparatus comprising:
receiving, at a first resource tracking system from a first computing device, an executable script;
executing, by the first resource tracking system, the executable script to generate transfer instructions;
implementing, by the first resource tracking system, a transfer based on the transfer instructions;
receiving, at the first resource tracking system, from a second computing device, a call to the executable script comprising proof of a transfer on a second resource tracking system;
executing, by the first resource tracking system in response to the call to the executable script, the executable script to generate second transfer instructions; and
implementing, by the resource tracking system, a second transfer based on the second transfer instructions.

2. The method of claim 1, further comprising:
wherein the executable script comprises an invokable escrow function that generates the transfer instructions, an invokable resolving function that generates the second transfer instructions, and an invokable cancel function that generates third transfer instructions and destroys the executable script.

3. The method of claim 2, wherein executing, by the first resource tracking system, the executable script to generate transfer instructions further comprises invoking the escrow function of the executable script, and wherein the transfer instructions comprise instructions to transfer a specified quantity of first resource type from a first resource pool on the first resource tracking system to a second resource pool on the resource tracking system.

4. The method of claim 3, wherein executing, by the first resource tracking system in response to the call to the executable script, the executable script to generate second transfer instructions further comprises invoking the resolving function of the executable script, wherein the resolving function verifies the proof of the transfer on the second resource tracking system using at least one cryptographic public key, and wherein second transfer instructions comprise instructions to transfer the specified quantity of the first resource type from the second resource pool on the first resource tracking system to a third resource pool on the resource tracking system, the third resource pool identified in the call to the executable script.

5. The method of claim 4, wherein the resolving function further verifies a second executable script stored on the second resource tracking system using at least one cryptographic public key.

6. The method of claim 5, wherein the second executable script comprises an invokable second escrow function that generates fourth transfer instructions, an invokable second resolving function that generates the fifth transfer instructions, and an invokable second cancel function that generates sixth transfer instructions and destroys the second executable script.

7. The method of claim 6, wherein the second cancel function verifies proof of cancellation before generating the sixth transfer instructions and destroying the second executable script, and wherein the proof of cancellation is generated based on invocation of the cancel function of the executable script on the first resource tracking system.

8. The method of claim 3, further comprising, before receiving, at the first resource tracking system, from a second computing device, the call to the executable script comprising the proof of a transfer on the second resource tracking system, receiving from the first computing device a call to the executable script invoking the cancel function.

9. The method of claim 8, wherein the cancel function verifies a cancel message received with the call to the executable script invoking the cancel function using at least one cryptographic public key, generates the third transfer instructions wherein the third transfer instructions comprise instruction to transfer the specified quantity of the first resource type from the second resource pool to the first resource pool on the first resource tracking system, and destroys the executable script on the first resource tracking system.

10. A resource-tracking system comprising:
one or more computing devices; and
a storage on at least one of the one or more computing devices, the one or more computing devices configured to:
receive an executable script from a first client computing device, execute the executable script to generate transfer instructions, implement a transfer based on the transfer instructions, receive a call to the executable script comprising proof of a transfer on a second resource tracking system from a second client computing device, execute in response to the call to the executable script the executable script to generate second transfer instructions, and implement a second transfer based on the second transfer instructions.

11. The system of claim 10, wherein the executable script comprises an invokable escrow function that generates the transfer instructions, an invokable resolving function that generates the second transfer instructions, and an invokable cancel function that generates third transfer instructions and destroys the executable script.

12. The system of claim 11, wherein the one or more computing devices are further configured to execute the executable script to generate transfer instructions by invoking the escrow function of the executable script, and wherein the transfer instructions comprise instructions to transfer a specified quantity of first resource type from a first resource pool in the storage to a second resource pool in the storage

13. The system of claim 12, wherein the one or more computing devices are further configured to, in response to the call to the executable script, execute the executable script to generate second transfer instructions further by invoking the resolving function of the executable script, wherein the resolving function verifies the proof of the transfer on the second resource tracking system using at least one cryptographic public key, and wherein the second transfer instructions comprise instructions to transfer the specified quantity of the first resource type from the second resource pool in the storage to a third resource pool in the storage, the third resource pool identified in the call to the executable script.

14. The system of claim 13, wherein the resolving function further verifies a second executable script stored on the second resource tracking system using at least one cryptographic public key.

15. The system of claim 14, wherein the second executable script comprises an invokable second escrow function that generates fourth transfer instructions, an invokable second resolving function that generates the fifth transfer instructions, and an invokable second cancel function that generates sixth transfer instructions and destroys the second executable script.

16. The system of claim 15, wherein the second cancel function verifies proof of cancellation before generating the sixth transfer instructions and destroying the second executable script, and wherein the proof of cancellation is generated based on invocation of the cancel function of the executable script on the resource tracking system.

17. The system of claim 12, wherein the one or more computing devices are further configured to, before receiving, at the first resource tracking system, from a second client computing device, the call to the executable script comprising the proof of a transfer on the second resource tracking system, receive from the first client computing device a call to the executable script invoking the cancel function.

18. The system of claim 17, wherein the cancel function verifies a cancel message received with the call to the executable script invoking the cancel function using at least one cryptographic public key, generates the third transfer instructions wherein the third transfer instructions comprise instruction to transfer the specified quantity of the first resource type from the second resource pool to the first resource pool in the storage, and destroys the executable script on the resource tracking system.

19. A system comprising: one or more computers and one or more storage devices storing instructions which are operable, when executed by the one or more computers, to cause the one or more computers to perform operations comprising:
receiving, at a first resource tracking system from a first computing device, an executable script;
executing, by the first resource tracking system, the executable script to generate transfer instructions;
implementing, by the first resource tracking system, a transfer based on the transfer instructions;
receiving, at the first resource tracking system, from a second computing device, a call to the executable script comprising proof of a transfer on a second resource tracking system;
executing, by the first resource tracking system in response to the call to the executable script, the executable script to generate second transfer instructions; and
implementing, by the resource tracking system, a second transfer based on the second transfer instructions.

20. The system of claim 19, wherein the executable script comprises an invokable escrow function that generates the transfer instructions, an invokable resolving function that generates the second transfer instructions, and an invokable cancel function that generates third transfer instructions and destroys the executable script.
